(19) United States
(12) Patent Application Publication
(10) Pub. No.: US 2025/0031229 A1
(43) Pub. Date: Jan. 23, 2025

(54) METHOD FOR MANAGING CARRIERS, AND DEVICE

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN); Boyuan ZHANG, Dongguan (CN)

(21) Appl. No.: 18/904,301

(22) Filed: Oct. 2, 2024

Related U.S. Application Data
(63) Continuation of application No. PCT/CN2022/088779, filed on Apr. 24, 2022.

(51) Int. Cl. H04W 72/40; H04W 72/02; H04W 72/20; H04W 92/18

(52) U.S. Cl. CPC H04W 72/40; H04W 72/02; H04W 72/20; H04W 92/18

(57) ABSTRACT

Provided is a method for managing carriers. The method is applicable to a first terminal. The method includes: performing carrier management on at least two carriers with a second terminal in carrier aggregation-based sidelink communication. The terminal includes a processor; a transceiver, communicably connected to the processor; and a memory, configured to store one or more executable instructions of the processor; wherein the processor, when loading and executing the one or more executable instructions, is caused to perform the method.

### CROSS-REFERENCE TO RELATED APPLICATION

This application is a continuation application of International Application No. PCT/CN2022/088779, filed Apr. 24, 2022, the entire disclosure of which is incorporated herein by reference.

### TECHNICAL FIELD

The present disclosure relates to the field of sidelink communications, and in particular, relates to a method and apparatus for managing carriers, and a device and a medium.

### BACKGROUND

In sidelink communication, a first terminal directly transmits sidelink data to a second terminal, and in this course, the sidelink data does not need to be forwarded by a base station to a second terminal. The sidelink communication may be applicable to device-to-device (D2D) communications.

### SUMMARY

Embodiments of the present disclosure provide a method and apparatus for managing carriers, and a device and a medium. The technical solutions include at least one of the following solutions.

According to some embodiments of the present disclosure, a method for managing carriers is provided. The method is applicable to a first terminal, and includes:
performing carrier management on at least two carriers with a second terminal in CA-based sidelink communication.

According to some embodiments of the present disclosure, a terminal is provided. The terminal includes: a processor; a transceiver communicably connected to the processor; and a memory configured to store one or more executable instructions of the processor, wherein the processor, when loading and executing the one or more executable instructions, is caused to perform the method for managing carriers as described above.

According to an aspect of the present disclosure, a chip is provided. The chip includes one or more programmable logic circuits and/or one or more program instructions, and the chip, when running, is caused to perform the method for managing carriers as described above.

### BRIEF DESCRIPTION OF THE DRAWINGS

For clearer descriptions of the technical solutions according to the embodiments of the present disclosure, the accompanying drawings required for describing the embodiments are briefly introduced hereinafter. Apparently, the accompanying drawings in the following description show merely some embodiments of the present disclosure, and those of ordinary skill in the art may still derive other drawings from these accompanying drawings without creative efforts.

FIG. 1 is a schematic diagram of an operation scenario of sidelink transmission in the related art;

FIG. 2 is a schematic diagram of an operation scenario of sidelink transmission in the related art;

FIG. 3 is a schematic diagram of an operation scenario of sidelink transmission in the related art;

FIG. 4 is a flowchart of a method for managing carriers according to some embodiments of the present disclosure;

FIG. 5 is a schematic diagram of a method for managing carriers according to some embodiments of the present disclosure;

FIG. 6 is a schematic diagram of a method for controlling carriers according to some embodiments of the present disclosure;

FIG. 7 is a schematic diagram of another method for controlling carriers according to some embodiments of the present disclosure;

FIG. 8 is a schematic diagram of a method for controlling carriers according to some embodiments of the present disclosure;

FIG. 9 is a schematic diagram of a method for controlling carriers according to some embodiments of the present disclosure;

FIG. 10 is a schematic diagram of a method for measuring and configuring carriers according to some embodiments of the present disclosure;

FIG. 11 is a schematic diagram of a method for measuring and configuring carriers according to some embodiments of the present disclosure;

FIG. 12 is a schematic diagram of a method for measuring and configuring carriers according to some embodiments of the present disclosure;

FIG. 13 is a schematic diagram of a method for measuring and configuring carriers according to some embodiments of the present disclosure;

FIG. 14 is a schematic diagram of a method for measuring and configuring carriers according to some embodiments of the present disclosure;

FIG. 15 is a schematic diagram of a method for detecting carrier RLF according to some embodiments of the present disclosure;

FIG. 16 is a schematic diagram of a method for controlling carriers according to some embodiments of the present disclosure;

FIG. 17 is a schematic diagram of a method for controlling carriers according to some embodiments of the present disclosure;

FIG. 18 is a schematic diagram of a method for controlling carriers according to some embodiments of the present disclosure;

FIG. 19 is a schematic diagram of a method for controlling carriers according to some embodiments of the present disclosure;

FIG. 20 is a schematic diagram of a method for measuring and configuring carriers according to some embodiments of the present disclosure;

FIG. 21 is a schematic diagram of a method for measuring and configuring carriers according to some embodiments of the present disclosure;

FIG. 22 is a schematic diagram of a method for measuring and configuring carriers according to some embodiments of the present disclosure;

FIG. 23 is a schematic diagram of a method for measuring and configuring carriers according to some embodiments of the present disclosure;

FIG. 24 is a schematic diagram of a method for detecting carrier RLF according to some embodiments of the present disclosure;

FIG. 25 is a schematic diagram of a method for detecting carrier RLF according to some embodiments of the present disclosure;

FIG. 26 is a schematic diagram of a method for detecting carrier RLF according to some embodiments of the present disclosure;

FIG. 27 is a structural block diagram of an apparatus for selecting carriers according to some embodiments of the present disclosure; and

FIG. 28 is a schematic structural diagram of a communication device for selecting carriers according to some embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings. Some embodiments are described in detail herein, examples of which are illustrated in the accompanying drawings. When the following description relates to the accompanying drawings, the same numerals in different accompanying drawings represent the same or similar elements unless otherwise indicated. The embodiments described in the following some embodiments do not represent all embodiments consistent with the present disclosure. Rather, they are merely examples of apparatus and methods that are described in detail in the appended claims and consistent with certain aspects of the present disclosure.

The terms used in the present disclosure are for the purpose of describing specific embodiments only and are not intended to limit the present disclosure. As used in the present disclosure and the appended claims, the articles “a,” “an,” and “the” are intended to include the plural forms as well, unless the context clearly indicates otherwise. It should also be understood that the phrase “and/or” as used herein refers to and encompasses any or all possible combinations of one or more associated listed items.

It should be understood that although the terms “first,” “second,” “third,” and the like may be used herein to describe various information, such information should not be limited to these terms. These terms are only used to distinguish one type of information from another. For example, first information may also be referred to as second information, and similarly, second information may also be referred to as first information, without departing from the scope of the present disclosure. The phrase “in a case that,” as used herein, may be interpreted as “in the case that,” “in the case of,” or “when,” “upon,” or “in response to determining” depending on the context.

First, the related technical background content involved in the embodiments of the present disclosure is described as follows.

LTE D2D/Vehicle-to-X (V2X): Device-to-device communication is a sidelink (SL) transmission technology based on D2D, also referred to as a sidelink communication technology. The sidelink communication system, unlike the conventional cellular system in which communication data is received or transmitted by a base station, adopts a method of direct device-to-device communication, and thus has higher spectral efficiency and lower transmission delay. In the 3^{rd} Generation Partnership Project (3GPP), two transmission modes are defined for sidelink communication.

Mode A: Transmission resources of a terminal are allocated by a base station, and the terminal transmits data on the sidelink based on the resources allocated by the base station. The base station may allocate resources to the terminal for single transmission, or allocate resources to the terminal for semi-static transmission.

Mode B: A terminal selects resources from a resource pool autonomously for the transmission of data.

In the sidelink communication system, taking the terminal user equipment (UE) described above as an example, the operating scenarios are mainly as follows.

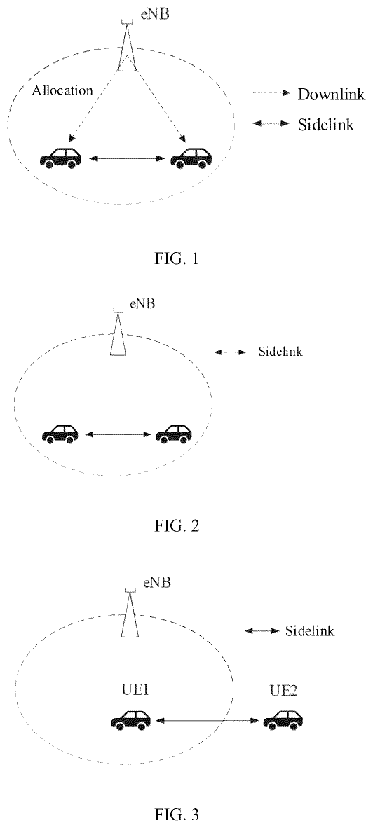

As shown in FIG. 1, two UEs are within network coverage and located in the same cell, a base station allocates sidelink transmission resources to the two UEs, and the two UEs perform data transmission on a sidelink based on the resources allocated by the base station.

In FIG. 2, two UEs are within network coverage and located in the same cell, and each of the UEs selects resources from a resource pool autonomously to perform data transmission on a sidelink.

In FIG. 3, a UE 1 is located within network coverage, and a UE 2 is located beyond network coverage. The UE 1 is a receiver terminal, and the UE 2 is a transmitter terminal. Alternatively, the UE 1 is a transmitter terminal, and the UE 2 is a receiver terminal. The UE 1 receives transmission resources allocated by a base station to perform sidelink communication with the UE 2, or the UE 1 selects resources from the transmission resources allocated by the base station to perform sidelink communication with the UE 2 based on a configuration requirement transmitted by the UE 2. In addition, the UE 1 selects resources from a resource pool autonomously to perform sidelink communication with the UE 2, or the UE 1 selects resources from the resource pool autonomously to perform sidelink communication with the UE 2 based on a configuration requirement transmitted by the UE 2.

In the 3GPP, D2D has been studied in different stages.

Proximity based service (ProSc): ProSe scenarios have been studied in D2D communication in 3GPP Release 12 and Release 13 (Rel-12/13), which is mainly directed to public safety services. In the ProSe, the position of the resource pool in the time domain is configured, for example, the resource pool is discontinuously configured in the time domain, and therefore, the UE transmits/receives data discontinuously on the SL, such that power saving is achieved.

Vehicle-to-everything (V2X): In Rel-14/15, vehicle-to-vehicle communication scenarios were studied in the V2X system, which is mainly directed to services of relatively high-speed moving vehicle-to-vehicle and vehicle-to-human communications. In the V2X, as the in-vehicle system has a continuous power supply, power efficiency is not a major issue, while the delay of data transmission is a major issue, and therefore, continuous transmission and reception by the terminal device is required in the system design.

Further enhanced device-to-device (FeD2D): In Rel-14, scenarios in which a wearable device accesses a network by a mobile phone have been studied in the FeD2D, which is mainly directed to scenarios with low moving speeds and low power access. In the FeD2D, in the preliminary research phase of 3GPP, it has been concluded that the base station configures the discontinuous reception (DRX) parameter of the remote terminal by one relay terminal, but as the project has not proceeded further into the standardization phase, the details on how to perform DRX configuration are not concluded.

NR V2X: new radio (NR) V2X, based on LTE V2X, is not limited to a broadcast scenario, but is further expanded to unicast and multicast scenarios where V2X applications are studied.

Similar to LTE V2X, NR V2X also defines two resource authorization modes described above, mode A (named as Mode-1 in NR V2X) and mode B (named as Mode-2 in NR V2X). Further, a user may be in a mixed mode, that is, Mode-1 and Mode-2 may be used for resource acquisition simultaneously. The resource acquisition is indicated by means of sidelink authorization, that is, the sidelink authorization indicates a corresponding time-frequency position of physical sidelink control channel (PSCCH) and physical sidelink shared channel (PSSCH) resources.

Unlike LTE V2X, in addition to the feedback-free and UE-initiated hybrid automatic repeat request (HARQ) retransmission, NR V2X introduces feedback-based HARQ retransmission, which is not limited to unicast communication but also includes multicast communication.

LTE-V2X CA: Carrier selection in LTE-V2X carrier aggregation (CA) is completed based on the following mechanisms.

An upper layer configures a mapping relationship between a service type and a carrier, that is, for a service type, the upper layer indicates available carriers (set) for an access stratum (AS).

Furthermore, the AS layer configures a carrier set available for each logical channel and a channel busy ratio (CBR) measurement threshold configured for data priority in each resource pool. A UE measures a CBR value in the resource pool and compares the measured CBR value with a CBR threshold corresponding to the priority of transmitted data, and in the case that the measured CBR value is lower than the CBR threshold, the carrier is considered to be available.

NR Uu CA: CA is a supported bandwidth extension technology since the advent of the long term evolution advanced (LTE-Advanced) standard, which allows a plurality of component carriers (CCs) to be aggregated together and received or transmitted simultaneously by one UE. CA may be further classified into intra-band CA and inter-band CA according to the range of aggregated carriers. Intra-band CA is primarily used for scenarios where the bandwidth of a cell carrier is greater than a bandwidth capability of a single carrier of the UE. In this case, the UE is capable of implementing operations in a “wide carrier” by using CA. For example, a base station supports a single carrier of 300 MHz, while the UE only supports a carrier of a maximum of 100 MHz. In this case, the UE may implement operations for broadband greater than 100 MHz by using CA, and the aggregated carriers may be adjacent carriers or non-adjacent carriers.

In the case that a terminal communicates with a network by using CA, a primary cell (PCell) and a secondary cell (SCell) may be configured simultaneously. In NR R15, a beam failure recovery mechanism is designed for the PCell and a secondary primary cell (PSCell), and implements mainly four functional modules (or main processes):
Beam failure detection (BFD)
New beam identification (NBI)
Beam failure recovery request (BFRQ)
Network side response

The terminal measures a physical downlink control channel (PDCCH) and judges link quality corresponding to a downlink transmission beam. In the case that the link quality is poor, it is considered that a beam failure occurs to the downlink beam. The terminal further measures a set of alternative beams, from which the terminal selects a beam that satisfies a specific threshold as a new beam. The terminal then notifies the network that a beam failure has occurred, and reports the new beam by a BFRQ procedure. Upon receiving BFRQ information from one terminal, the network knows that a beam failure has occurred at the terminal, and chooses to transmit a PDCCH on the new beam. The terminal that receives a PDCCH from the network on the new beam is considered to have correctly received the response information from the network side. As such, the BFRQ procedure is successful.

It should be understood that in some embodiments of the present disclosure, cells and carriers are equivalent. For example, a “first carrier” may be replaced with a “first cell,” a “second carrier” may be replaced with a “second cell,” and so on.

It should be understood that in some embodiments of the present disclosure, a “5G NR system” may also be referred to as a 5G system or an NR system. The technical solutions described in some embodiments of the present disclosure are applicable to 5G NR systems, subsequent evolution systems of the 5G NR systems, or 6G and subsequent evolution systems.

In the related art, a sidelink transmission resource used by the first terminal is selected autonomously from a resource pool or configured by the base station. However, some limitations are placed to the use of the sidelink transmission resource, which results in limited performance of a sidelink communication system.

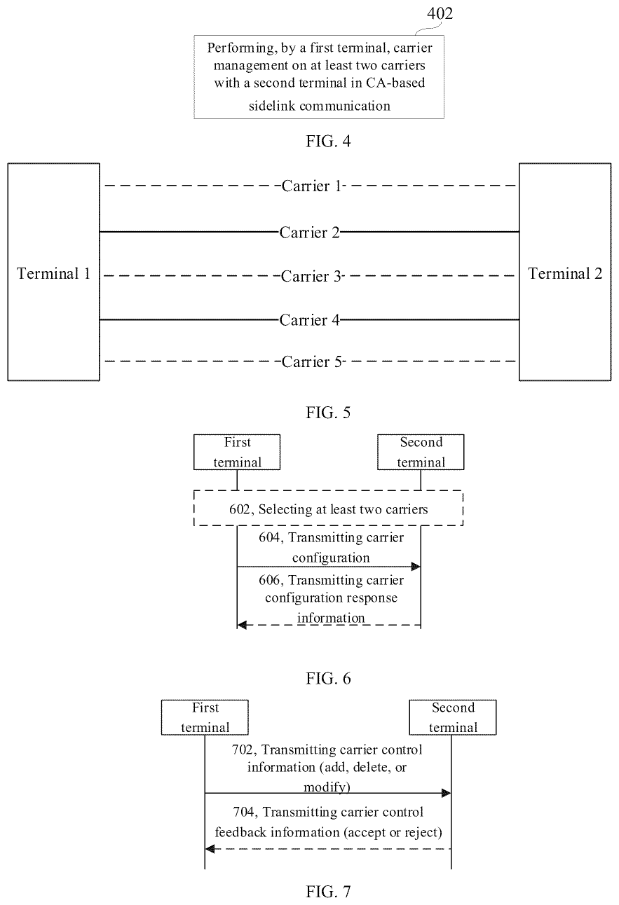

FIG. 4 is a flowchart of a method for managing carriers according to some embodiments of the present disclosure. The method is applicable to a first terminal. The method includes the following processes.

In process 402, a first terminal perform carrier management on at least two carriers with a second terminal in CA-based sidelink communication.

Illustratively, the CA-based sidelink communication refers to a CA-introduced NR SL. The first terminal and the second terminal select at least two carriers to perform the CA-based sidelink communication based on at least one of self-implementation, a mapping relationship, a selection configuration, or a selection rule.

In some embodiments, information used in a self-implementation process is pre-defined or pre-configured. In some embodiments, the mapping relationship is pre-configured, or configured via a Uu interface, or configured via a PC5 interface. In some embodiments, the selection configuration is pre-configured, or configured via a Uu interface, or configured via a PC5 interface. In some embodiments, the selection rule is pre-configured, or configured via a Uu interface, or configured via a PC5 interface. The present disclosure does not limit how to determine or select or decide the at least two carriers by the first terminal and/or the second terminal. Illustratively, as shown in FIG. 5, five available carriers or candidate carriers are present for sidelink data transmission on a sidelink between the first terminal and the second terminal, the first terminal and the second terminal select a carrier 2 and a carrier 4 for carrier management, and the first terminal performs the CA-based sidelink communication with the second terminal over the carrier 2 and carrier 4.

In a CA-based sidelink communication process, the first terminal and the second terminal perform carrier management on at least two carriers. The at least two carriers are used for CA.

Upon performing CA using at least two carriers by the first terminal and the second terminal, the first terminal and the second terminal cooperate or negotiate to perform carrier management on all or part of the at least two carriers. That is, the first terminal and the second terminal cooperate or negotiate to perform carrier management on at least one of the at least two carriers. The carrier management includes at least one of: adding at least one carrier; deleting at least one carrier; modifying at least one carrier; monitoring at least one carrier where RLF occurs; performing carrier measurement on at least one carrier; or performing carrier recovery on at least one carrier where RLF occurs.

In some embodiments, the at least two carriers are not distinguished as primary and secondary carriers, or the two carriers have the same status. For example, in the process of performing sidelink communication between the first terminal and the second terminal, the first terminal selects two carriers for CA, and the two carriers are not distinguished as the primary and secondary carriers.

In some embodiments, the at least two carriers are distinguished as primary and secondary carriers, or the two carriers have different statuses. For example, in the process of performing sidelink communication between the first terminal and the second terminal, the first terminal selects three carriers for CA, and the three carriers are distinguished as one primary carrier and two secondary carriers.

In some embodiments, the first terminal is a transmitter terminal, and the second terminal is a receiver terminal; or, the first terminal is a receiver terminal, and the second terminal is a transmitter terminal.

In some embodiments, the method according to the embodiments is applicable to at least one of unicast communication, multicast communication, or broadcast communication. That is, one or more second terminals are deployed. Description is given in the embodiments based on an example in which one first terminal and one second terminal are deployed in unicast communication, which is not limited in the present disclosure.

It should be noted that the “carrier” herein may also be understood as, in different contexts, a carrier identifier, a carrier index, a carrier frequency, or other meanings, and is not limited to the literal meaning of the carrier.

It should be understood that the process of performing the method for managing carriers by the second terminal is easily conceivable by those skilled in the art based on the above examples, which is not described herein any further.

In summary, in the method according to the embodiments, with the introduction of the CA, the terminal may autonomously or substantially autonomously perform carrier management (such as carrier addition, carrier deletion, carrier modification, RLF detection, and carrier recovery) on at least two carriers involved in the CA. In this way, dependence on a network device in a sidelink communication process is reduced, such that normal operation of the CA is also ensured in a partial network coverage scenario or a scenario without network coverage, and thus data transmission performance on a sidelink is improved, and transmission performance of a sidelink communication system is enhanced.

The present disclosure provides at least eight different methods for managing carriers, which may be divided into two types:

Type 1: Primary and secondary carriers are not distinguished.
Carrier control/configuration
Radio resource management (RRM)
RLF detection
RLF recovery

Type 2: Primary and secondary carriers are distinguished.
Carrier control

The carrier control may be primarily managed by a transmitter terminal or by a receiver terminal. The carrier control may be performed for the primary carrier or for the secondary carrier.
RRM
RLF detection
RLF recovery

### Some Embodiments of Carrier Control/Configuration-Primary and Secondary Carriers are not Distinguished

### Mode 1: Without PC5-Radio Resource Control (RRC)

FIG. 6 is a schematic diagram of a method for controlling/configuring carriers according to some embodiments of the present disclosure. Description is given in the embodiments based on an example in which the method is applicable to a terminal. The method includes at least part of the following processes.

In process 602, the first terminal and the second terminal select at least two carriers.

The first terminal and/or the second terminal select at least two carriers based on self-implementation, and/or a first mapping relationship, and/or a first selection rule, and/or a first selection configuration.

The “self-implementation” herein refers to a mode in which the terminal selects a carrier without the involvement of a network device, but the information used in the self-implementation process may be pre-defined or pre-configured.

The first mapping relationship is a mapping relationship for selecting a carrier for CA, and the first mapping relationship includes the mapping relationship between attribute of a sidelink and a carrier. The first mapping relationship may be pre-defined, or configured by the network device for the first terminal, or configured by the second terminal for the first terminal.

The attribute of the sidelink includes at least one of: a service type, an application type, a layer 2 identity (ID), a transmission attribute (Tx profile), a data transmission type, quality of service (QOS), a logical channel, a resource pool, a radio bearer, a data priority, or a resource pool congestion degree. The resource pool congestion degree may be measured based on a CBR.

The first selection rule is a selection rule for selecting a carrier involved in the CA. The first selection rule is pre-configured, or configured via the Uu interface, or configured via the PC5 interface. In some embodiments, the first selection rule includes: configuring, by the AS layer, a carrier set available for each logical channel and a CBR measurement threshold configured for the priority of data in each resource pool; and measuring, by the terminal, the CBR value in the resource pool, comparing the CBR value with the CBR threshold corresponding to the priority of the transmitted data, and considering that the carrier is available in the case that the measured CBR value is lower than the CBR threshold.

The first selection configuration is a selection configuration for selecting a carrier involved in the CA. The first selection configuration is pre-configured, or configured via the Uu interface, or configured via the PC5 interface. In some embodiments, the first selection configuration involves configuring a carrier set by the network device for the terminal, wherein the carrier set includes at least two available carriers or candidate carriers. The first terminal and the second terminal select at least two carriers from the carrier set. In some embodiments, the first selection configuration involves directly configuring at least two carriers for the first terminal, and the first terminal directly uses the at least two carriers as carriers involved in the CA.

In some embodiments, the first mapping relationship, the first selection rule, and the first selection configuration may be used in combination.

In some embodiments, the first terminal is a transmitter terminal, and the second terminal is a receiver terminal; and/or, the first terminal is a receiver terminal, and the second terminal is a transmitter terminal. In the case that the first terminal is a transmitter terminal, one or more second terminals may be deployed.

In some embodiments, the first terminal or the second terminal selects at least two carriers based on at least one of the following attributes of the sidelink: a service type; an application type; a transmission attribute; a data transmission type; QoS; a layer 2 ID; a logical channel mapping; a resource pool; a radio bearer; a data priority; a resource pool congestion degree; or link quality or channel condition of a candidate carrier.

In some embodiments, the first terminal or the second terminal monitors all available carriers in the vicinity for selecting the at least two carriers.

In process 604, the first terminal transmits a carrier configuration to the second terminal.

Using a scenario where the first terminal completes the determination, or selection, or decision of the at least two carriers, the first terminal transmits the carrier configuration of the at least two carriers to the second terminal. The at least two carriers are carriers determined or selected or decided by the first terminal for participating in the CA.

In some embodiments, the first terminal independently transmits PC5-RRC configuration information of each of the at least two carriers over the carrier. In some embodiments, the first terminal transmits the PC5-RRC configuration information of the i^{th} carrier over the i^{th} carrier, i is a positive integer.

In process 606, the second terminal transmits carrier configuration response information to the first terminal.

The carrier configuration response information is response information transmitted by the second terminal based on the carrier configuration transmitted by the first terminal. The carrier configuration response information includes at least one of: a configuration acceptance, a configuration rejection, a configuration failure, a configuration success, a rejection reason, or a suggested carrier configuration.

In some embodiments, the second terminal independently transmits the carrier configuration response information of each of the at least two carriers over the carrier. In some embodiments, the second terminal transmits the carrier configuration response information of the i^{th} carrier over the i^{th} carrier, i is a positive integer.

The second terminal may accept or reject the carrier configuration of the at least two carriers from the first terminal. That is, the carrier configuration response information includes at least one of: a configuration acceptance, a configuration rejection, a configuration success, a configuration failure, a rejection reason, or a suggested carrier configuration.

In some embodiments, the second terminal accepts the carrier configuration of the at least two carriers from the first terminal and transmits the carrier configuration response information to the first terminal. In some embodiments, the second terminal directly uses or enables or activates the carrier configuration and considers that the configuration is successful, without the need to transmit the carrier configuration response to the first terminal. The first terminal and the second terminal use the configured at least two carriers to perform the CA-based sidelink communication.

In some embodiments, the second terminal rejects the carrier configuration of the at least two carriers from the first terminal, or considers that the configuration fails, or feeds back the rejection reason to the first terminal, or suggests a new carrier configuration to the first terminal.

In the case that the carrier configuration response information indicates that the second terminal rejects the carrier configuration or the configuration fails, the first terminal performs at least one of: carrier re-configuration, considering that an RLF has occurred on the current carrier, or disconnecting the sidelink between the first terminal and the second terminal. For example, in the case that all carrier configurations are rejected by the second terminal, the first terminal disconnects the sidelink between the first terminal and the second terminal.

Carrier re-configuration involves repeating at least one of processes 602 and 604 between the first terminal and the second terminal to process the configuration of the at least two carriers in the case that the second terminal rejects the configuration of all or part of the carriers or the configuration of all or part of the carriers fails.

In summary, in the method according to the embodiments, the terminal may autonomously or substantially autonomously select to configure at least two carriers for CA and independently transmit the carrier configuration information over each of the at least two carriers, so as to reduce dependence on the network device in the sidelink communication process and improve the success rate of carrier configuration, such that normal operation of the CA is also ensured in a partial network coverage scenario or a scenario without network coverage, and thus data transmission performance on the sidelink is improved, and transmission performance of the sidelink communication system is enhanced.

### Mode 2: With PC5-RRC

FIG. 7 is a schematic diagram of a method for controlling/configuring carriers according to some embodiments of the present disclosure. Description is given in the embodiments based on an example in which the method is applicable to a terminal. The method includes at least part of the following processes.

In process 702, the first terminal transmits carrier control information to the second terminal.

The first terminal transmits the carrier control information to the second terminal over a sidelink message.

The sidelink message is PC5-RRC signaling, or medium access control (MAC) control element (CE) signaling, or physical layer signaling, such as a PSCCH message or a physical sidelink feedback channel (PSFCH) message.

The carrier control information is used for performing at least one of an add operation, a delete operation, or a modify operation on the at least two carriers.

The add operation refers to adding the carrier in the case that the carrier is not present in a carrier list used on the current sidelink.

The delete operation refers to deleting the carrier in the case that the carrier is present in the carrier list used on the current sidelink, and stopping the sidelink communication over the carrier.

The modify operation refers to performing a corresponding modify operation on parameters corresponding to the carrier in the case that the carrier is present in the carrier list used on the current sidelink. The parameters include at least one of: a frequency identity (Freq ID), a sub-carrier space (SCS), an absolute frequency point A, an absolute frequency synchronization signal block (Absolute Frequency SSB), a frequency shift, a bandwidth part (BWP), a synchronization configuration (Sync Configuration), or a synchronization priority (Sync Priority).

In some embodiments, the first terminal is a transmitter terminal, and the second terminal is a receiver terminal; and/or, the first terminal is a receiver terminal, and the second terminal is a transmitter terminal. In the case that the first terminal is a transmitter terminal, one or more second terminals are deployed.

In some embodiments, in the case that the first terminal is in a connected state and/or mode 1, and the network device supports sidelink CA, the carrier control information is transmitted to the first terminal by the network device. In some embodiments, the carrier control information is generated by the first terminal itself.

In some embodiments, the first terminal indicates a carrier to be controlled by the carrier control information using a carrier sequence number, or controls the current carrier by the carrier control information. The current carrier refers to a carrier that transmits the carrier control information, for example, the carrier control information is transmitted over the carrier 3, the carrier control information is used to perform carrier control on the carrier 3.

In process 704, the second terminal transmits carrier control feedback information to the first terminal.

The second terminal transmits the carrier control feedback information to the first terminal over a sidelink message.

The carrier control feedback information is response information transmitted by the second terminal based on the carrier control information transmitted by the first terminal. The feedback information includes at least one of: a control acceptance, a control rejection, a control failure, a control success, a rejection reason, or a suggested carrier control.

In some embodiments, the second terminal accepts control of the at least two carriers from the first terminal, and for the carrier control information, the second terminal transmits the carrier control feedback information indicating the control acceptance to the first terminal. In some embodiments, the second terminal directly uses or enables or activates the carrier control and considers that the control is successful, without the need to transmit the carrier control feedback information to the first terminal. The first terminal and the second terminal perform the CA-based sidelink communication using the configured at least two carriers.

In some embodiments, the second terminal rejects the control of the at least two carriers from the first terminal, and for the carrier control information, the second terminal transmits the carrier control feedback information indicating the control rejection to the first terminal; or the control is considered to fail, or the rejection reason is fed back to the first terminal, or new carrier control is suggested to the first terminal.

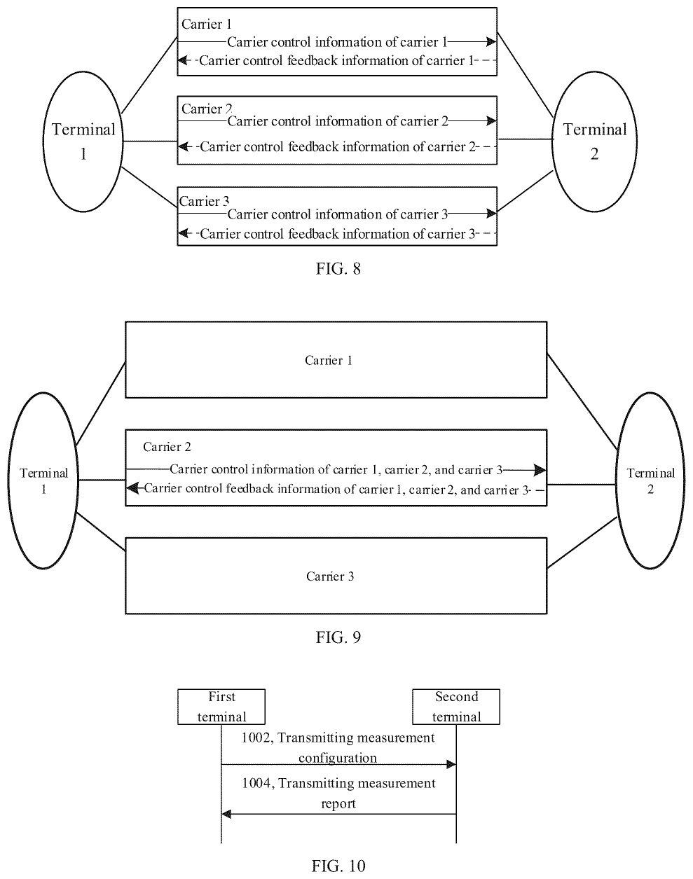

In some embodiments, the carrier control information and the carrier control feedback information of the at least two carriers are transmitted independently over each corresponding carrier. Illustratively, as shown in FIG. 8, three available carriers are present between the terminal 1 and the terminal 2: a carrier 1, a carrier 2, and a carrier 3. The terminal 1 transmits carrier control information corresponding to the three carriers respectively to the terminal 2, and the carrier control information of each of the three carriers is carried over the corresponding carrier and transmitted independently. Accordingly, the terminal 2 transmits the carrier control feedback information corresponding to the three carriers to the terminal 1, and the carrier control feedback information of each of the three carriers is carried over the corresponding carrier and transmitted independently. That is, the carrier control information of the carrier 1 is carried over the carrier 1 and is transmitted by the terminal 1 to the terminal 2. The carrier control feedback information of the carrier 1 is carried over the carrier 1 and is transmitted by the terminal 2 to the terminal 1. The carrier control information of the carrier 2 is carried over the carrier 2 and is transmitted by the terminal 1 to the terminal 2. The carrier control feedback information of the carrier 2 is carried over the carrier 2 and is transmitted by the terminal 2 to the terminal 1. The carrier control information of the carrier 3 is carried over the carrier 3 and is transmitted by the terminal 1 to the terminal 2. The carrier control feedback information of the carrier 3 is carried over the carrier 3 and is transmitted by the terminal 2 to the terminal 1.

In some embodiments, the carrier control information and the carrier control feedback information of the at least two carriers are carried over a first carrier of the at least two carriers for transmission, and the first carrier is at least one of the at least two carriers. The carrier control information indicates a carrier controlled by the carrier control information in the case of cross-carrier transmission of the carrier control information over the first carrier.

In some embodiments, the first terminal selects the first carrier based on self-implementation, and/or a second mapping relationship, and/or a second selection rule, and/or a second selection configuration. The second mapping relationship is a mapping relationship for selecting a carrier for transmitting the carrier control information. The second selection rule is a selection rule for selecting a carrier for transmitting the carrier control information. The second selection configuration is a selection configuration for selecting a carrier for transmitting the carrier control information.

In some embodiments, self-implementation refers to the internal implementation of the terminal in the process of selecting the (first) carrier without the involvement of a network device. However, the information used in the self-implementation process is pre-defined or pre-configured. In some embodiments, at least one of the second mapping relationship, the second selection rule, or the second selection configuration is pre-configured, or configured via the Uu interface, or configured via the PC5 interface. The self-implementation, the second mapping relationship, the second selection rule, and the second selection configuration may be used in combination or individually.

Illustratively, as shown in FIG. 9, three available carriers are present between the terminal 1 and the terminal 2: a carrier 1, a carrier 2, and a carrier 3. The terminal 1 selects the carrier 2 as a first carrier based on the self-implementation. The terminal 1 transmits the carrier control information of the three carriers to the terminal 2, the carrier control information of the three carriers is all carried over the carrier 2 for transmission, and each piece of carrier control information indicates a controlled carrier. Accordingly, the terminal 2 transmits the carrier control feedback information of the three carriers to the terminal 1, the carrier control feedback information of the three carriers is carried over carrier 2 for transmission, and the carrier control feedback information indicates a fed-back carrier.

It should be noted that each piece of carrier control information may control one or more carriers. Each piece of carrier control feedback information may be used for feeding back the feedback information of one or more carriers. In the case that the same carrier control information controls a plurality of carriers, the carrier control for each of the plurality of carriers may be the same or uniform, or may be different or independent. In the case that the same carrier control feedback information is used for feeding back a plurality of carriers, the carrier control feedback for each of the plurality of carriers may be the same or uniform, or may be different or independent. For example, the terminal 1 transmits one piece of carrier control information to the terminal 2 for carrier addition of the carrier 1, the carrier 2, and the carrier 3, and the terminal 2 transmits one piece of carrier control feedback information to the terminal 1 for accepting the carrier addition of the carrier 1 and the carrier 2 and rejecting the carrier addition of the carrier 3.

In the case that the carrier control feedback information indicates that the second terminal rejects the carrier control or the control fails, the first terminal performs at least one of: carrier re-configuration, considering that an RLF has occurred on the current carrier, and disconnecting the sidelink between the first terminal and the second terminal. For example, in the case that all carrier configurations are rejected by the second terminal, the first terminal disconnects the sidelink between the first terminal and the second terminal.

Carrier re-configuration involves repeating at least one of process 702 or process 704 between the first terminal and the second terminal to perform the control process for the at least two carriers in the case that the second terminal rejects the carrier control or the control fails.

In some embodiments, upon completion of process 702 by the first terminal, the second terminal does not perform process 704.

In some embodiments, the mode 2 shown in FIG. 7 is only used for the unicast link between the first terminal and the second terminal.

In some embodiments, the mode 2 shown in FIG. 7 is used based on the mode 1 shown in FIG. 6.

In summary, in the method according to the embodiments, the terminal may autonomously or substantially autonomously select to configure at least two carriers for CA and independently transmit the carrier configuration information over each of the at least two carriers, so as to reduce dependence on the network device in the sidelink communication process and improve the success rate of carrier configuration, such that normal operation of the CA is also ensured in a partial network coverage scenario or a scenario without network coverage, such that data transmission performance on the sidelink is improved, and transmission performance of the sidelink communication system is enhanced.

### RRM-Primary and Secondary Carriers are not Distinguished

FIG. 10 is a schematic diagram of a method for measuring and configuring carriers according to some embodiments of the present disclosure. Description is given in the embodiments based on an example in which the method is applicable to a terminal. The method includes at least part of the following processes.

In process 1002, the first terminal transmits measurement configuration of at least one carrier to the second terminal.

The first terminal transmits the measurement configuration of at least one carrier, that is, transmits the RRM measurement configuration of at least one carrier. RRM measurement mainly uses a synchronization signal block (SSB) and a channel state information reference signal (CSI-RS) as reference signals. The SSB-based RRM measurement configuration includes at least one an SSB frequency point, a measurement time configuration, or a reference signal configuration. The CSI-RS-based RRM configuration includes at least one of a time-domain or a frequency-domain position occupied by the CSI-RS resource, a sequence generation mode, or an associated SSB.

In some embodiments, the first terminal is a transmitter terminal, and the second terminal is a receiver terminal; and/or, the first terminal is a receiver terminal, and the second terminal is a transmitter terminal. In the case that the first terminal is a transmitter terminal, one or more second terminals are deployed.

In process 1004, the second terminal transmits a measurement report of at least one carrier to the first terminal.

The measurement report includes a channel condition acquired by the second terminal upon measurement of a reference signal based on the measurement configuration transmitted by the first terminal. The measurement report is transmitted by the second terminal to the first terminal.

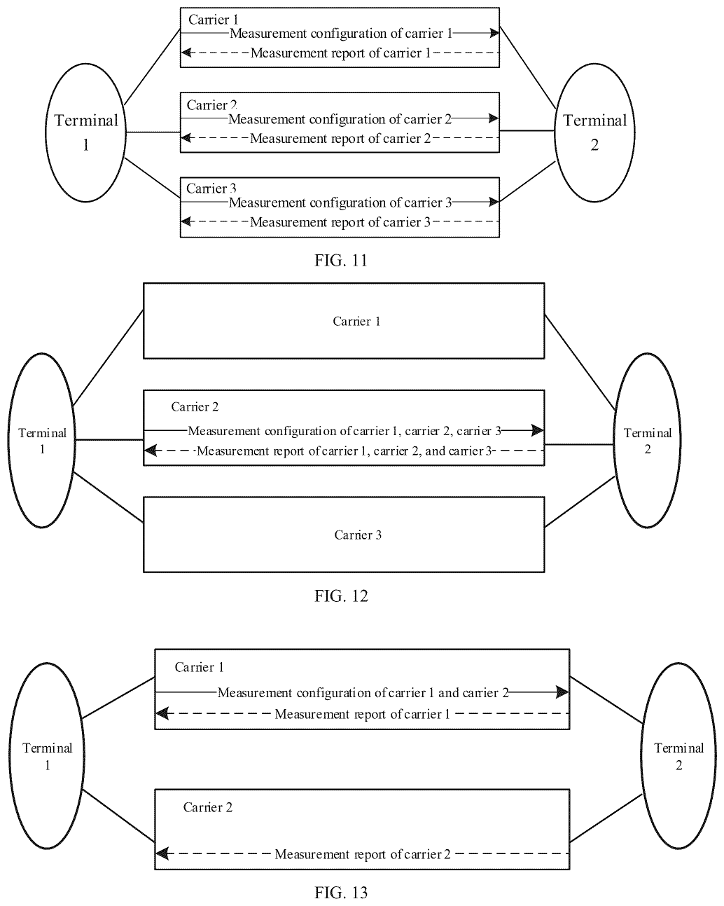

In some embodiments, the measurement configuration and/or the measurement reports of the at least two carriers are transmitted independently on each corresponding carrier, that is, the measurement configuration and/or the measurement report are carried over each of the at least two carriers for independent transmission. Illustratively, as shown in FIG. 11, three available carriers are present between the terminal 1 and the terminal 2: carrier 1, carrier 2, and carrier 3. The terminal 1 transmits to the terminal 2 the measurement configurations corresponding to the three carriers, the measurement configuration of each of the three available carriers is carried over the corresponding carrier for independent transmission, the terminal 2 transmits the measurement reports corresponding to the three carriers to the terminal 1, and the measurement report of each carrier is carried over the corresponding carrier for independent transmission.

In some embodiments, the measurement configuration and/or the measurement reports of the at least two carriers are carried over a second carrier of the at least two carriers for transmission, and the second carrier is at least one of the at least two carriers. In the case of cross-carrier transmission of the measurement configuration over the second carrier, a carrier measured by the measurement configuration is indicated; in the case of cross-carrier transmission of the measurement report over the second carrier, a carrier measured by the measurement report is indicated; and in the case of cross-carrier transmission of the measurement configuration and the measurement report over the second carrier, a carrier measured by the measurement configuration and measurement report is indicated. That is, in the case of cross-carrier transmission of the measurement configuration and/or the measurement report, the measurement configuration and/or the measurement report of the i^{th} carrier are carried and transmitted over the second carrier, and the measurement configuration and/or the measurement report indicate the i^{th} carrier. The i^{th} carrier is a carrier different from the second carrier among the at least two carriers.

In some embodiments, the first terminal selects the second carrier based on self-implementation, and/or a third mapping relationship, and/or a third selection rule, and/or a third selection configuration. The third mapping relationship is a mapping relationship for a selecting carrier for transmitting the measurement configuration and/or the measurement report. The third selection rule is a selection rule for selecting a carrier for transmitting the measurement configuration and/or the measurement report. The third selection configuration is a selection configuration for selecting a carrier for transmitting the measurement configuration and/or the measurement report.

In some embodiments, self-implementation refers to the internal implementation of the terminal in the process of selecting the (second) carrier without the involvement of a network device. The information used in the selection of the second carrier based on the self-implementation is pre-defined or pre-configured. In some embodiments, at least one of the third mapping relationship, the third selection rule, or the third selection configuration is pre-configured, or configured via the Uu interface, or configured via the PC5 interface. The self-implementation, the third mapping relationship, the third selection rule, and the third selection configuration may be used in combination or individually.

In some embodiments, taking an example where the i^{th} carrier is carrier i, the measurement configuration and/or the measurement report of the carrier i among the at least two carriers are transmitted over the second carrier, and the measurement configuration and/or the measurement report indicate a carrier identifier of the carrier i. In the case that the measurement configuration and/or the measurement report of the second carrier are transmitted over the second carrier, the measurement configuration and/or the measurement report may indicate a carrier identifier of the second carrier or may not indicate the carrier identifier of the second carrier (implicit indication, no carrier identifier indicates the corresponding current carrier).

Illustratively, as shown in FIG. 12, three available carriers are present between the terminal 1 and the terminal 2: carrier 1, carrier 2, and carrier 3. The terminal 1 transmits the measurement configurations corresponding to the three carriers to the terminal 2, the measurement configurations of the three carriers are all carried over the carrier 2 for transmission, and the measurement configurations of the three carriers indicate measured carrier 1, carrier 2, and carrier 3. Accordingly, the terminal 2 transmits the measurement reports corresponding to the three carriers to the terminal 1, and the measurement reports of the three carriers are all carried over the carrier 2 for transmission, and the measurement reports of the three carriers indicate measured carrier 1, carrier 2, and carrier 3.

In some embodiments, the terminal 1 transmits a piece of information including the measurement configuration to the terminal 2, wherein the information includes a measurement configuration of the carrier 1 (indicating the carrier 1 using a carrier identifier), a measurement configuration of the carrier 2 (indicating the carrier 2 using a carrier identifier), and a measurement configuration of the carrier 3 (indicating the carrier 3 using a carrier identifier). Accordingly, the terminal 2 transmits a piece of information including the measurement report to the terminal 1, wherein the information includes a measurement report of the carrier 1 (indicating the carrier 1 using a carrier identifier), a measurement report of the carrier 2 (indicating the carrier 2 using a carrier identifier), and a measurement report of the carrier 3 (indicating the carrier 3 using a carrier identifier). In some embodiments, the terminal 2 transmits three pieces of information including the measurement reports to the terminal 1, wherein the three pieces of information are: information including the measurement report of the carrier 1 (indicating the carrier 1 using a carrier identifier), information including the measurement report of the carrier 2 (indicating the carrier 2 using a carrier identifier), and information including the measurement report of the carrier 3 (indicating the carrier 3 using a carrier identifier), respectively.

In some embodiments, the terminal 1 transmits three pieces of information including the measurement configurations to the terminal 2, and the three pieces of information are: information including the measurement configuration of the carrier 1 (indicating the carrier 1 using a carrier identifier), information including the measurement configuration of the carrier 2 (indicating the carrier 2 using a carrier identifier), and information including the measurement configuration of the carrier 3 (indicating the carrier 3 using a carrier identifier), respectively. Accordingly, the terminal 2 transmits a piece of information including the measurement report to the terminal 1, wherein the information includes a measurement report of the carrier 1 (indicating the carrier 1 using a carrier identifier), a measurement report of the carrier 2 (indicating the carrier 2 using a carrier identifier), and a measurement report of the carrier 3 (indicating the carrier 3 using a carrier identifier). In some embodiments, the terminal 2 transmits three pieces of information including the measurement reports to the terminal 1, wherein the three pieces of information are: information including the measurement report of the carrier 1 (indicating the carrier 1 using a carrier identifier), information including the measurement report of the carrier 2 (indicating the carrier 2 using a carrier identifier), and information including the measurement report of the carrier 3 (indicating the carrier 3 using a carrier identifier), respectively.

In some embodiments, the measurement configuration of carrier i among the at least two carriers is transmitted over the second carrier, the measurement configuration indicates the carrier i, and the measurement report is transmitted over the carrier i.

Illustratively, as shown in FIG. 13, two available carriers are present between the terminal 1 and the terminal 2: a carrier 1 and a carrier 2. The terminal 1 transmits the measurement configurations corresponding to the two carriers to the terminal 2 over the carrier 1. The terminal 2 transmits the measurement reports corresponding to the two carriers to the terminal 1, the measurement report of the carrier 1 is transmitted over the corresponding carrier 1, and the measurement report of the carrier 2 is transmitted over the corresponding carrier 2.

In some embodiments, the measurement report of carrier i among the at least two carriers is transmitted over the second carrier, the measurement report indicates the carrier i, and the measurement configuration is transmitted over the carrier i.

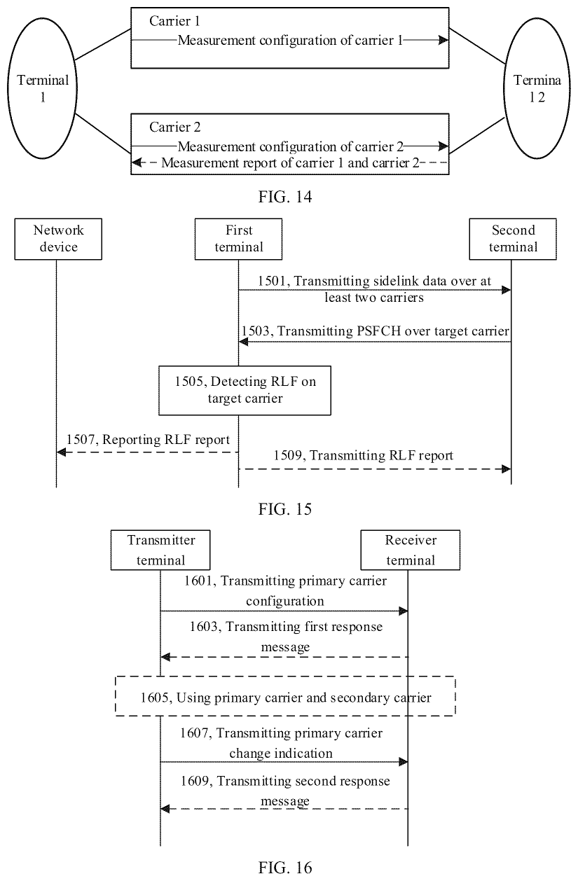

Illustratively, as shown in FIG. 14, two available carriers are present between the terminal 1 and the terminal 2: a carrier 1 and a carrier 2. The terminal 1 transmits the measurement configurations corresponding to the two carriers to the terminal 2, and the measurement configurations of the carrier 1 and the carrier 2 are transmitted over the respective corresponding carriers, that is, the measurement configuration of the carrier 1 is transmitted over the carrier 1, and the measurement configuration of the carrier 2 is transmitted over the carrier 2. The terminal 2 transmits the measurement reports corresponding to the two carriers to the terminal 1 over the carrier 2, the RRM measurement report of the carrier 1 is transmitted over the carrier 2, and the measurement report indicates the carrier 1; the measurement report of the carrier 2 is transmitted over the carrier 2, and the measurement report indicates the carrier 2.

### RLF Detection-Primary and Secondary Carriers are not Distinguished

FIG. 15 is a schematic diagram of a method for detecting carrier RLF according to some embodiments of the present disclosure. Description is given in the embodiments based on an example in which the method is applicable to a terminal. The method includes at least part of the following processes.

In process 1501, the first terminal transmits a plurality of pieces of sidelink data over at least two carriers.

The first terminal independently transmits a physical sidelink shared channel (PSSCH) of each of the at least two carriers to the second terminal over the carrier. The PSSCH may also be understood as data carried over the PSSCH, referred to as sidelink data.

In some embodiments, the first terminal is a transmitter terminal, and the second terminal is a receiver terminal. In the case that the first terminal is a transmitter terminal, one or more second terminals are deployed.

In process 1503, the second terminal transmits a plurality of PSFCHs over a target carrier.

The second terminal transmits feedback information to the first terminal over the target carrier among the at least two carriers. The feedback information is used for feeding back whether the sidelink data of the carrier is correctly received, Illustratively, the feedback information is a PSFCH. In the case of correct reception, the feedback content of the feedback information may be an acknowledgment (ACK); and in the case of erroneous reception, the feedback content of the feedback information may be a negative acknowledgment (NACK). In some embodiments, a plurality of PSFCHs have a mapping relationship with a plurality of PSSCHs, such as a one-to-one mapping relationship, or a one-to-many mapping relationship, or a many-to-one mapping relationship.

In some embodiments, the target carrier is each of the at least two carriers, that is, the PSFCH corresponding to the PSSCH of the i^{th} carrier is carried over the i^{th} carrier for transmission. In some embodiments, the target carrier is a third carrier among the at least two carriers. The third carrier is a carrier selected from the at least two carriers, but the possibility of a plurality of third carriers is not excluded.

In some embodiments, the first terminal selects the third carrier based on self-implementation, and/or a fourth mapping relationship, and/or a fourth selection rule, and/or a fourth selection configuration. The fourth mapping relationship is a mapping relationship for selecting a carrier for transmitting the PSFCH. The fourth selection rule is a selection rule for selecting a carrier for transmitting the PSFCH. The fourth selection configuration is a selection configuration for selecting a carrier for transmitting the PSFCH.

In some embodiments, self-implementation refers to the internal implementation of the terminal in the process of selecting the (third) carrier without the involvement of a network device. However, the information used in the selection of the third carrier based on the self-implementation is pre-defined or pre-configured. In some embodiments, at least one of the fourth mapping relationship, the fourth selection rule, or the fourth selection configuration is pre-configured, or configured via the Uu interface, or configured via the PC5 interface. The self-implementation, the fourth mapping relationship, the fourth selection rule, or the fourth selection configuration may be used in combination or individually.

In some embodiments, the first terminal transmits the indication information of the third carrier to the second terminal, or the first terminal receives the indication information of the third carrier from the second terminal, or the first terminal receives the indication information of the third carrier from a network device.

In process 1505, the first terminal detects RLF on the target carrier.

The first terminal detects the PSFCH of a plurality of pieces of sidelink data transmitted by the second terminal over the target carrier.

In some embodiments, in the case that the target carrier is each of the at least two carriers, the first terminal performs independent detection or combined detection on the plurality of PSFCHs independently transmitted by the second terminal over each of the at least two carriers. The PSFCH on each carrier corresponds to the sidelink data on each carrier.

In some embodiments, the first terminal independently detects RLF for each of the at least two carriers, that is, independently detects the plurality of PSFCHs independently transmitted by the second terminal over each carrier, and determines that an RLF has occurred on a fourth carrier in the case that the first terminal detects the loss of the PSFCHs for N consecutive pieces of sidelink data on the fourth carrier. The value of N is a default value, or a fixed value, or a value configured by the network, or a value configured by the second terminal, or a value autonomously determined by the first terminal. The fourth carrier is one of the at least two carriers.

It should be noted that detecting the loss of the PSFCHs for N consecutive pieces of sidelink data on the fourth carrier includes: each of the N consecutive PSFCHs received on the fourth carrier being either lost or NACK.

In some embodiments, the first terminal performs combined detection of RLF on the at least two carriers, that is, performs combined detection on the plurality of PSFCHs independently transmitted by the second terminal over each of the at least two carriers. In the case that the first terminal detects the loss of the PSFCHs for M consecutive pieces of sidelink data on the at least two carriers, the first terminal determines that an RLF has occurred on the sidelink corresponding to the at least two carriers, that is, the RLF has occurred on the entire sidelink between the first terminal and the second terminal.

It should be noted that detecting the loss of the PSFCHs for M consecutive pieces of sidelink data on the at least two carriers includes: each of the M consecutive PSFCHs cumulatively received on all of the at least two carriers being either lost or NACK.

The value of M is a default value, or a fixed value, or a value configured by the network, or a value configured by the second terminal, or a value autonomously determined by the first terminal. The fourth carrier is one of the at least two carriers. N is a threshold defined for a single carrier, and M is a threshold defined for at least two carriers or sidelink. Typically, M is greater than or equal to N.

Illustratively, three candidate carriers are present between the terminal 1 and the terminal 2: a carrier 1, a carrier 2, and a carrier 3. The terminal 1 transmits a plurality of pieces of sidelink data to the terminal 2 over the three carriers, the terminal 2 transmits PSFCHs of the plurality of pieces of sidelink data to the terminal 1 over the three carriers, and the terminal 1 performs combined detection on the PSFCHs transmitted by the terminal 2 over the three carriers. In the case of detecting the loss or NACK of M consecutive PSFCHs on the carrier 1 and the carrier 3, the terminal 1 determines that an RLF has occurred on the sidelink corresponding to the three carriers, that is, the RLF has occurred on the entire sidelink between the terminal 1 and the terminal 2.

In some embodiments, in the case that the target carrier is a third carrier among the at least two carriers, the first terminal performs independent detection or combined detection on a plurality of PSFCHs transmitted by the second terminal over the third carrier. The plurality of PSFCHs have a mapping relationship with the plurality of pieces of sidelink data on the at least two carriers. In some embodiments, the mapping relationship is configured by the first terminal for the second terminal, or the first terminal receives the mapping relationship configured by the second terminal, or the first terminal receives the mapping relationship configured by the network device.

In some embodiments, the first terminal performs independent detection of RLF on one of the at least two carriers, that is, detects the plurality of PSFCHs transmitted by the second terminal over the third carrier, and determines that an RLF has occurred on the fourth carrier in the case that the first terminal detects the loss of the PSFCHs for N consecutive pieces of sidelink data corresponding to the fourth carrier on the third carrier. The value of N is a default value, or a fixed value, or a value configured by the network, or a value configured by the second terminal, or a value autonomously determined by the first terminal. The fourth carrier is one of the at least two carriers.

It should be noted that detecting the loss of the PSFCHs for N consecutive pieces of sidelink data corresponding to the fourth carrier on the third carrier includes: each of the N consecutive PSFCHs received on the third carrier and corresponding to the fourth carrier being either lost or NACK.

In some embodiments, the first terminal performs combined detection of RLF on the at least two carriers, that is, performs combined detection on the plurality of PSFCHs transmitted by the second terminal over the third carrier, and in the case that the first terminal detects the loss of the PSFCHs for M consecutive pieces of sidelink data on the third carrier, the first terminal determines that an RLF has occurred on the sidelink corresponding to the at least two carriers, that is, the RLF has occurred on the entire sidelink between the first terminal and the second terminal. The value of M is a default value, or a fixed value, or a value configured by the network, or a value configured by the second terminal, or a value autonomously determined by the first terminal.

It should be noted that detecting the loss of the PSFCHs for M consecutive pieces of sidelink data on the third carrier includes: each of the M consecutive PSFCHs cumulatively received on all of the at least two carriers being either lost or NACK.

Illustratively, three candidate carriers are present between the terminal 1 and the terminal 2: a carrier 1, a carrier 2, and a carrier 3. The terminal 1 transmits a plurality of pieces of sidelink data to the terminal 2 over the three carriers, the terminal 2 transmits PSFCHs having a mapping relationship with the plurality of pieces of sidelink data to the terminal 1 over the carrier 3, and the terminal 1 detects the PSFCHs transmitted by the terminal 2 over the carrier 3. In the case of detecting the loss or NACK for M consecutive PSFCHs on the carrier 3, the terminal 1 determines that an RLF has occurred on the sidelink corresponding to the three carriers, that is, the RLF has occurred on the entire sidelink between the terminal 1 and the terminal 2.

The value of M is a default value, or a fixed value, or a value configured by the network, or a value configured by the second terminal, or a value autonomously determined by the first terminal. Typically, M is greater than N.

In some embodiments, the first terminal configures a mapping relationship between the sidelink data and the PSFCH for the second terminal; and/or, the first terminal receives the mapping relationship between the sidelink data and the PSFCH configured by the second terminal; and/or, the first terminal receives the mapping relationship between the sideline data and the PSFCH configured by the network device.

In process 1507, the first terminal reports an RLF report to the network device in the case that an RLF has occurred on a carrier.

In some embodiments, in the case that an RLF has occurred on one or more of the at least two carriers, the first terminal reports the RLF report of the one or more carriers to the network device over an uplink carrier. In some embodiments, the RLF report is reported to the network device in an independent message form; or the RLF report of each of the at least two carriers is reported to the network device in a list form. The list includes the RLF report of each of the at least two carriers, and the RLF report of each of the at least two carriers is used for indicating whether RLF has occurred on the current carrier.

In some embodiments, the RLF report is carried over PC5-RRC signaling, or MAC CE signaling, or physical layer signaling.

In process 1509, the first terminal transmits an RLF report to the second terminal in the case that an RLF has occurred on a carrier.

In some embodiments, in the case that an RLF has occurred on one or more of the at least two carriers, the first terminal transmits an RLF report of the one or more carriers to the second terminal over the target carrier. In some embodiments, the RLF report of the one or more carriers is transmitted to the second terminal in an independent message form; or the RLF report of each of the at least two carriers is transmitted to the second terminal in a list form. The list includes the RLF report of each of the at least two carriers, and the RLF report of each of the at least two carriers is used for indicating whether an RLF has occurred on the current carrier.

In some embodiments, the RLF report is carried over PC5-RRC signaling, or MAC CE signaling, or physical layer signaling.

In some embodiments, the RLF report is transmitted over other carriers where RLF has not occurred.

In some embodiments, in the case that an RLF has occurred on the fourth carrier among the at least two carriers, or RLF has occurred on the fourth carrier and at least one carrier where RLF has not occurred is present, the first terminal performs carrier reselection.

In some embodiments, the first terminal disconnects the sidelink between the first terminal and the second terminal in the case that an RLF has occurred on the sidelink.

### RLF Recovery-Primary and Secondary Carriers are not Distinguished

According to some embodiments of the present disclosure, a method for recovering carriers is provided. Description is given in the embodiments based on an example in which the method is applicable to a terminal.

In some embodiments, the first terminal performs RLF detection on at least two carriers. In the case that an RLF has occurred on the fourth carrier among the at least two carriers, or an RLF has occurred on the fourth carrier and at least one carrier where an RLF has not occurred is present, the first terminal performs carrier reselection; and/or, in the case that an RLF has occurred on the at least two carriers or the entire sidelink, the first terminal disconnects the sidelink between the first terminal and the second terminal.

### Embodiments of Carrier Control-Primary and Secondary Carriers are Distinguished

### Embodiments of Primary Carrier Control-Primary and Secondary Carriers are Distinguished

FIG. 16 is a schematic diagram of a method for controlling a carrier according to some embodiments of the present disclosure. Description is given in the embodiments based on an example in which the method is applicable to a terminal. The method includes at least part of the following processes.

In process 1601, the transmitter terminal transmits a primary carrier configuration to the receiver terminal.

The transmitter terminal transmits a primary carrier configuration to the receiver terminal; and the primary carrier is at least one of: a carrier used by the transmitter terminal when transmitting a first message to the receiver terminal; a carrier corresponding to the LCH with the highest priority based on a mapping relationship between a logical channel (LCH) and a carrier; a carrier with the lowest CBR measurement value in an available carrier set; a carrier with the best channel quality in the available carrier set, such as a carrier with the highest reference signal receiving power (RSRP); a carrier suggested or expected or configured by the receiver terminal; or a carrier configured by the network device.

The first message includes at least one of: a discovery message; a direct communication request (DCR) message; a first piece of data information; or a first PC5-RRC message.

In some embodiments, one or more receiver terminals are deployed.

In some embodiments, the transmitter terminal is one of the first terminal and the second terminal, and the receiver terminal is the other of the first terminal and the second terminal.

In process 1603, the receiver terminal transmits a first response message for the primary carrier configuration to the transmitter terminal (optional).

The first response message is response information transmitted by the receiver terminal based on the primary carrier configuration transmitted by the transmitter terminal, and the first response information includes at least one of: primary carrier configuration acceptance, primary carrier configuration rejection, primary carrier configuration failure, primary carrier configuration success, rejection reason, or suggested primary carrier configuration.

In some embodiments, the receiver terminal accepts the primary carrier configuration from the transmitter terminal and transmits the first response message to the transmitter terminal; or, the receiver terminal directly uses or enables or activates the primary carrier configuration and considers that the configuration is successful, without the need to transmit the first response message to the transmitter terminal.

In some embodiments, the receiver terminal rejects the primary carrier configuration from the transmitter terminal, or considers that the primary carrier configuration fails, or feeds back the rejection reason to the transmitter terminal, or suggests a new primary carrier configuration to the transmitter terminal.

In process 1605, the transmitter terminal and the receiver terminal perform sidelink communication over the primary carrier and at least one secondary carrier.

In the case that the first response message indicates that the receiver terminal accepts the primary carrier configuration or the primary carrier configuration is successful, the transmitter terminal and the receiver terminal perform CA-based sidelink communication over the configured primary carrier and at least one secondary carrier.

In the case that the first response message indicates that the receiver terminal rejects the primary carrier configuration or the primary carrier configuration fails, the transmitter terminal and the receiver terminal perform the CA-based sidelink communication using a default or pre-configured or arbitrary carrier as the primary carrier.

In process 1607, the transmitter terminal transmits a primary carrier change indication to the receiver terminal.

The primary carrier change indication is used for changing the primary carrier configuration and is transmitted by the transmitter terminal to the receiver terminal. The primary carrier change indication is physical layer information, or MAC layer information, or RRC information.

In some embodiments, the primary carrier change indication is transmitted by the transmitter terminal in the case that at least one of the following trigger modes is satisfied:
a periodically triggered mode; or
an event-triggered mode.

Illustratively, the period value is a fixed value, or a value configured by the network device, or a value autonomously determined by the transmitter terminal, or a value configured by the receiver terminal.

Illustratively, the transmitter terminal transmits the primary carrier change indication upon the occurrence of at least one of the following events:
RLF occurs on the primary carrier prior to change;
an RLF report from the receiver terminal is received, wherein the RLF report indicates that an RLF has occurred on the primary carrier prior to change;
the CBR value on the primary carrier prior to change is greater than a threshold;
the primary carrier prior to change is not in the configured available carrier set;
a primary carrier change request from the receiver terminal is received; or a primary carrier change indication from the network device is received.

In some embodiments, the primary carrier change indication is carried and transmitted over the primary carrier prior to change, and the primary carrier change indication carries an indication of the changed primary carrier, wherein the indication includes the position, serial number, identifier, or the like of the changed primary carrier; or the primary carrier change indication is carried and transmitted over the primary carrier upon change, and the primary carrier change indication carries an indication that the current carrier serves as the primary carrier; or the primary carrier change indication is carried and transmitted over a fifth carrier, wherein the fifth carrier is any one or more active carriers in the sidelink.

In process 1609, the receiver terminal transmits a second response message for the primary carrier change indication to the transmitter terminal (optional).

The second response message is response information transmitted by the receiver terminal based on the primary carrier change indication transmitted by the transmitter terminal, and the second response information includes at least one of: primary carrier change acceptance, primary carrier change rejection, primary carrier change failure, carrier change success, rejection reason, or suggested primary carrier change.

In some embodiments, the second response information indicates that the receiver terminal accepts the primary carrier change indication from the transmitter terminal and transmits a second response message to the transmitter terminal; or the receiver terminal directly uses, enables, or activates the primary carrier change indication and considers that the change is successful, without the need to transmit the second response message to the transmitter terminal. The transmitter terminal and the receiver terminal perform CA-based sidelink communication over the changed primary carrier.

In some embodiments, the second response information indicates that the receiver terminal rejects the primary carrier change indication from the transmitter terminal, or considers that the primary carrier change fails, or feeds back the rejection reason to the transmitter terminal, or suggests a new primary carrier change to the transmitter terminal. The transmitter terminal and the receiver terminal perform the CA-based sidelink communication using a default or unchanged primary carrier or an arbitrary carrier as the primary carrier.

In some embodiments, no primary carrier is available on the sidelink, and the link between the transmitter terminal and the receiver terminal is disconnected.

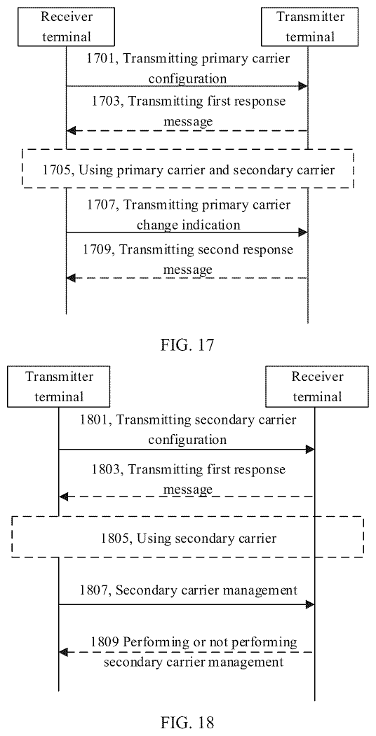

FIG. 17 is a schematic diagram of a method for controlling carriers according to some embodiments of the present disclosure. Description is given in the embodiments based on an example in which the method is applicable to a terminal. The method includes at least part of the following processes.

In process 1701, the receiver terminal transmits a primary carrier configuration to the transmitter terminal.

The receiver terminal transmits the primary carrier configuration to the transmitter terminal, and the primary carrier is at least one of:
a carrier with the lowest CBR measurement value in an available carrier set;
a carrier with the best channel quality in the available carrier set, such as a carrier with the highest RSRP;
a carrier suggested or expected or configured by the transmitter terminal;
a carrier monitored by the receiver terminal; or
a carrier configured by the network device.

In some embodiments, one or more receiver terminals are deployed.

In some embodiments, the transmitter terminal is one of the first terminal and the second terminal, and the receiver terminal is the other of the first terminal and the second terminal.

In process 1703, the transmitter terminal transmits a first response message for the primary carrier configuration to the receiver terminal (optional).

The first response message is response information transmitted by the transmitter terminal based on the primary carrier configuration transmitted by the receiver terminal. The first response information includes at least one of: primary carrier configuration acceptance, primary carrier configuration rejection, primary carrier configuration failure, primary carrier configuration success, rejection reason, or suggested primary carrier configuration.

In some embodiments, the transmitter terminal accepts the primary carrier configuration from the receiver terminal and transmits the first response message to the receiver terminal; or the transmitter terminal directly uses or enables or activates the primary carrier configuration and considers that the configuration is successful, without the need to transmit the first response message to the receiver terminal.

In some embodiments, the transmitter terminal rejects the primary carrier configuration from the receiver terminal, or considers that the primary carrier configuration fails, or feeds back the rejection reason to the receiver terminal, or suggests a new primary carrier configuration to the receiver terminal.

In process 1705, the receiver terminal and the transmitter terminal perform sidelink communication over the primary carrier and at least one secondary carrier.

In the case that the first response message indicates that the transmitter terminal accepts the primary carrier configuration or the primary carrier configuration is successful, the receiver terminal and the transmitter terminal perform CA-based sidelink communication over the configured primary carrier and at least one secondary carrier.

In the case that the first response message indicates that the transmitter terminal rejects the primary carrier configuration or the primary carrier configuration fails, the receiver terminal and the transmitter terminal perform the CA-based sidelink communication using a default or pre-configured or arbitrary carrier as the primary carrier.

In process 1707, the receiver terminal transmits a primary carrier change indication to the transmitter terminal.

The primary carrier change indication is used for changing the primary carrier configuration and is transmitted by the receiver terminal to the transmitter terminal. The primary carrier change indication is physical layer information, or MAC layer information, or RRC information.

In some embodiments, the primary carrier change indication is transmitted by the receiver terminal in the case that at least one of the following trigger modes is satisfied:
a periodically triggered mode; or
an event-triggered mode.

Illustratively, the period value is a fixed value, or a value configured by the network device, or a value autonomously determined by the receiver terminal, or a value configured by the transmitter terminal.

Illustratively, the receiver terminal transmits the primary carrier change indication upon occurrence of at least one of the following events:
an RLF report from the transmitter terminal is received, wherein the RLF report indicates that an RLF has occurred on the primary carrier prior to change;
the CBR value on the primary carrier prior to change is greater than a threshold;
the primary carrier prior to change is not in the configured available carrier set; or
a primary carrier change request from the transmitter terminal is received.

In some embodiments, the primary carrier change indication is carried and transmitted over the primary carrier prior to change, and the primary carrier change indication carries an indication of the changed primary carrier, wherein the indication includes the position, serial number, identifier, or the like of the changed primary carrier; or the primary carrier change indication is carried and transmitted over the primary carrier upon change, and the primary carrier change indication carries an indication that the current carrier serves as the primary carrier; or the primary carrier change indication is carried and transmitted over a fifth carrier, wherein the fifth carrier is any one or more active carriers in the sidelink.

In process 1709, the transmitter terminal transmits a second response message for the primary carrier change indication to the receiver terminal (optional).

The second response message is response information transmitted by the transmitter terminal based on the primary carrier change indication transmitted by the receiver terminal, and the second response information includes at least one of: primary carrier change acceptance, primary carrier change rejection, primary carrier change failure, primary carrier change success, rejection reason, or suggested primary carrier change.

In some embodiments, the transmitter terminal accepts the primary carrier change indication from the receiver terminal and transmits the second response message to the receiver terminal; or the transmitter terminal directly uses or enables or activates the primary carrier change indication and considers that the change is successful, without the need to transmit the second response message to the receiver terminal. The transmitter terminal and the receiver terminal perform CA-based sidelink communication over the changed primary carrier.

In some embodiments, the transmitter terminal rejects the primary carrier change indication from the receiver terminal, or considers that the primary carrier change fails, or feeds back the rejection reason to the receiver terminal, or suggests a new primary carrier change to the receiver terminal. The transmitter terminal and the receiver terminal perform the CA-based sidelink communication using a default or unchanged primary carrier or an arbitrary carrier as the primary carrier.

In some embodiments, no primary carrier is available on the sidelink, and the link between the transmitter terminal and the receiver terminal is disconnected.

### Embodiments of Secondary Carrier Control-Primary and Secondary Carriers are Distinguished

FIG. 18 is a schematic diagram of a method for controlling a carrier according to some embodiments of the present disclosure. Description is given in the embodiments based on an example in which the method is applicable to a terminal. The method includes at least part of the following processes.

In process 1801, the transmitter terminal transmits a secondary carrier configuration to the receiver terminal.

The transmitter terminal transmits a secondary carrier configuration to the receiver terminal, and the secondary carrier configuration is used for instructing to perform at least one of an add operation, a delete operation, or a modify operation on a secondary carrier.

The add operation refers to adding the secondary carrier in the case that the secondary carrier is not present in a secondary carrier list used on the current sidelink.

The delete operation refers to deleting the secondary carrier in the case that the secondary carrier is present in the secondary carrier list used on the current sidelink, and stopping the sidelink communication over the secondary carrier.

The modify operation refers to performing a corresponding modify operation on the parameters of the secondary carrier in the case that the secondary carrier is present in the secondary carrier list used on the current sidelink. The parameters include at least one of: a frequency ID, an SCS, an absolute frequency point A, an absolute frequency SSB, a frequency shift, a BWP, a synchronization configuration, or a synchronization priority.

In some embodiments, the secondary carrier configuration is transmitted over the primary carrier on the current sidelink.

In some embodiments, the secondary carrier configuration is carried over PC5-RRC signaling, or MAC CE signaling, or physical layer signaling.

In some embodiments, the secondary carrier configuration indicates the configured carrier using a carrier sequence number or a carrier identifier.

In some embodiments, in the case that the transmitter terminal is in a connected state and/or mode 1, and the network device supports sidelink CA, the secondary carrier configuration is transmitted to the transmitter terminal by the network device; or the secondary carrier configuration is generated by the transmitter terminal itself.

In some embodiments, one or more receiver terminals are deployed.

In some embodiments, the transmitter terminal is one of the first terminal and the second terminal, and the receiver terminal is the other of the first terminal and the second terminal.

In process 1803, the receiver terminal transmits a first response message for the secondary carrier configuration to the transmitter terminal (optional).

The first response message is response information transmitted by the receiver terminal based on the secondary carrier configuration transmitted by the transmitter terminal, and the first response information includes at least one of: secondary carrier configuration acceptance, secondary carrier configuration rejection, secondary carrier configuration failure, secondary carrier configuration success, rejection reason, or suggested secondary carrier configuration.

In some embodiments, the receiver terminal accepts the secondary carrier configuration from the transmitter terminal and transmits the first response message to the transmitter terminal; or the receiver terminal directly uses or enables or activates the secondary carrier configuration and considers that the configuration is successful, without the need to transmit the first response message to the transmitter terminal.

In some embodiments, the receiver terminal rejects the secondary carrier configuration from the transmitter terminal, or considers that the secondary carrier configuration fails, or feeds back the rejection reason to the transmitter terminal, or suggests a new secondary carrier configuration to the transmitter terminal.

In process 1805, the transmitter terminal and the receiver terminal perform sidelink communication over the secondary carrier.

In the case that the first response message indicates that the receiver terminal accepts the secondary carrier configuration or the secondary carrier configuration is successful, the transmitter terminal and the receiver terminal perform CA-based sidelink communication over the configured secondary carrier.

In the case that the first response message indicates that the receiver terminal rejects the secondary carrier configuration or the secondary carrier configuration fails, the transmitter terminal and the receiver terminal perform the CA-based sidelink communication over at least one secondary carrier prior to configuration, or the transmitter terminal disconnects the sidelink between the transmitter terminal and the receiver terminal.

In process 1807, the transmitter terminal manages the secondary carrier.

The secondary carrier management refers to the activation or deactivation management of the secondary carrier, which is performed by the transmitter terminal.

In some embodiments, the secondary carrier management is the activation of the secondary carrier. In some embodiments, the transmitter terminal transmits an activation indication for a first secondary carrier to the receiver terminal. The activation indication is transmitted over the primary carrier of the current sidelink, and the activation indication is physical layer signaling, or MAC CE signaling, or RRC signaling. In some embodiments, the transmitter terminal activates the first secondary carrier in response to expiration of a first timer. The first timer starts timing from the receiving moment or the transmitting moment of the last deactivation indication.

In some embodiments, the first secondary carrier is all or part of at least two carriers on the sidelink. The first secondary carrier is one or more secondary carriers.

In some embodiments, the timing value of the first timer is pre-configured, or configured by the network device, or autonomously decided by the transmitter terminal, or configured by the receiver terminal.

In some embodiments, the secondary carrier management is the deactivation of the secondary carrier. In some embodiments, the transmitter terminal transmits a deactivation indication for a second secondary carrier to the receiver terminal. The deactivation indication is transmitted over the primary carrier or the secondary carrier of the current sidelink, and the deactivation indication is physical layer signaling, or MAC CE signaling, or RRC signaling. In some embodiments, the transmitter terminal deactivates the secondary carrier in response to expiration of a second timer. The second timer starts timing from the receiving moment or the transmitting moment of the last activation indication.

In some embodiments, the second secondary carrier is all or part of at least two carriers on the sidelink. The second secondary carrier is one or more secondary carriers.

In some embodiments, the timing value of the second timer is pre-configured, or configured by the network device, or autonomously decided by the transmitter terminal, or configured by the receiver terminal.

In process 1809, the receiver terminal performs or does not perform secondary carrier management.

In some embodiments, the receiver terminal performs the secondary carrier management and performs the corresponding secondary carrier management based on the secondary carrier management indication transmitted by the transmitter terminal or in response to expiration of the timer.

In some embodiments, the receiver terminal activates the first secondary carrier and monitors the first secondary carrier; or the receiver terminal deactivates the second secondary carrier and does not monitor the second secondary carrier.

In some embodiments, the receiver terminal does not perform the secondary carrier management, or the receiver terminal rejects a secondary carrier management indication transmitted by the transmitter terminal, or the secondary carrier management fails, or the receiver terminal feeds back the rejection reason to the transmitter terminal, or the receiver terminal suggests new secondary carrier management to the transmitter terminal.

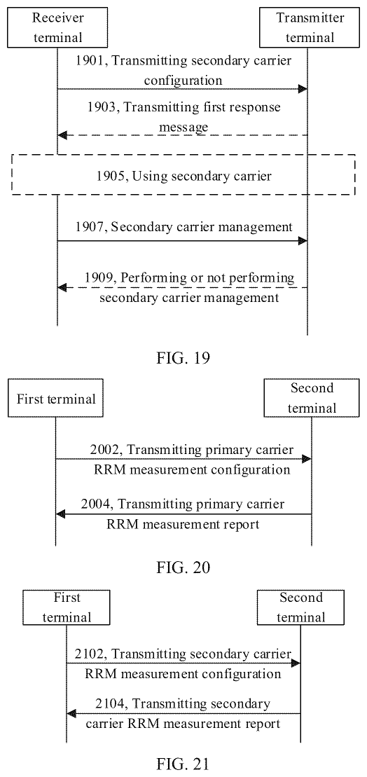

FIG. 19 is a schematic diagram of a method for controlling a carrier according to some embodiments of the present disclosure. The description is given in the embodiments based on an example in which the method is applicable to a terminal. The method includes at least part of the following processes.

In process 1901, the receiver terminal transmits a secondary carrier configuration to the transmitter terminal.

The receiver terminal transmits a secondary carrier configuration to the transmitter terminal, and the secondary carrier configuration is used for instructing to perform at least one of an add operation, a delete operation, or a modify operation on a secondary carrier.

The add operation refers to adding the secondary carrier in the case that the secondary carrier is not present in a secondary carrier list used on the current sidelink.

The delete operation refers to deleting the secondary carrier in the case that the secondary carrier is present in the secondary carrier list used on the current sidelink, and stopping the sidelink communication over the secondary carrier.

The modify operation refers to performing a corresponding modify operation on the parameters of the secondary carrier in the case that the secondary carrier is present in the secondary carrier list used on the current sidelink. The parameters include at least one of: a frequency ID, an SCS, an absolute frequency point A, an absolute frequency SSB, a frequency shift, a BWP, a synchronization configuration, or a synchronization priority.

In some embodiments, the secondary carrier configuration is transmitted over the primary carrier on the current sidelink.

In some embodiments, the secondary carrier configuration is carried over PC5-RRC signaling, or MAC CE signaling, or physical layer signaling.

In some embodiments, the secondary carrier configuration indicates the configured carrier using a carrier sequence number or a carrier identifier.

In some embodiments, in the case that the receiver terminal is in a connected state and/or mode 1, and the network device supports sidelink CA, the secondary carrier configuration is transmitted to the receiver terminal by the network device; or the secondary carrier configuration is generated by the receiver terminal itself.

In some embodiments, one or more receiver terminals are deployed.

In some embodiments, the transmitter terminal is one of the first terminal and the second terminal, and the receiver terminal is the other of the first terminal and the second terminal.

In process 1903, the transmitter terminal transmits a first response message for the secondary carrier configuration to the receiver terminal (optional).

The first response message is response information transmitted by the transmitter terminal based on the secondary carrier configuration transmitted by the receiver terminal, and the first response information includes at least one of: a secondary carrier configuration acceptance, a secondary carrier configuration rejection, a secondary carrier configuration failure, a secondary carrier configuration success, a rejection reason, or a suggested secondary carrier configuration.

In some embodiments, the transmitter terminal accepts the secondary carrier configuration from the receiver terminal and transmits the first response message to the receiver terminal; or the transmitter terminal directly uses or enables or activates the secondary carrier configuration and considers that the configuration is successful, without the need to transmit the first response message to the receiver terminal.

In some embodiments, the transmitter terminal rejects the secondary carrier configuration from the receiver terminal, or considers that the secondary carrier configuration fails, or feeds back the rejection reason to the receiver terminal, or suggests a new secondary carrier configuration to the receiver terminal.

In process 1905, the transmitter terminal and the receiver terminal perform sidelink communication over the secondary carrier.

In the case that the first response message indicates that the transmitter terminal accepts the secondary carrier configuration or the secondary carrier configuration is successful, the transmitter terminal and the receiver terminal use the configured secondary carrier to perform CA-based sidelink communication.

In the case that the first response message indicates that the transmitter terminal rejects the secondary carrier configuration or the secondary carrier configuration fails, the transmitter terminal and the receiver terminal perform the CA-based sidelink communication over at least one secondary carrier prior to configuration, or the receiver terminal disconnects the sidelink between the receiver terminal and the transmitter terminal.

In process 1907, the receiver terminal manages the secondary carrier.

The secondary carrier management refers to the activation or deactivation management of the secondary carrier, which is performed by the receiver terminal.

In some embodiments, the secondary carrier management is the activation of the secondary carrier. In some embodiments, the receiver terminal transmits an activation indication for a first secondary carrier to the transmitter terminal. The activation indication is transmitted over the primary carrier of the current sidelink, and the activation indication is physical layer signaling, or MAC CE signaling, or RRC signaling. In some embodiments, the receiver terminal activates the first secondary carrier in response to expiration of a timer. The timer starts timing from the receiving moment or the transmitting moment of the last deactivation indication.

In some embodiments, the first secondary carrier is all or part of at least two carriers on the sidelink. The first secondary carrier is one or more secondary carriers.

In some embodiments, the timing value of the first timer is pre-configured, or configured by the network device, or autonomously decided by the transmitter terminal, or configured by the receiver terminal.

In some embodiments, the secondary carrier management is the deactivation of the secondary carrier. In some embodiments, the receiver terminal transmits a deactivation indication for a second secondary carrier to the transmitter terminal. The deactivation indication is transmitted over the primary carrier or the secondary carrier of the current sidelink, and the deactivation indication is physical layer signaling, or MAC CE signaling, or RRC signaling. In some embodiments, the receiver terminal deactivates the second secondary carrier in response to expiration of the timer. The timer starts timing from the receiving moment or the transmitting moment of the last activation indication.

In some embodiments, the second secondary carrier is all or part of at least two carriers on the sidelink. The second secondary carrier is one or more secondary carriers.

In some embodiments, the timing value of the second timer is pre-configured, or configured by the network device, or autonomously decided by the receiver terminal, or configured by the transmitter terminal.

In process 1909, the transmitter terminal performs or does not perform secondary carrier management.

In some embodiments, the transmitter terminal performs the secondary carrier management and performs the corresponding secondary carrier management operation based on the secondary carrier management indication transmitted by the receiver terminal or in response to expiration of the timer.

In some embodiments, the transmitter terminal activates the first secondary carrier, then the first secondary carrier fails to be used for transmitting data on the sidelink; or the transmitter terminal deactivates the second secondary carrier, then the second secondary carrier fails to be used for receiving the data on the sidelink.

In some embodiments, the transmitter terminal does not perform the secondary carrier management, or the transmitter terminal rejects a secondary carrier management indication transmitted by the receiver terminal, or the secondary carrier management fails, or the transmitter terminal feeds back the rejection reason to the receiver terminal, or the transmitter terminal suggests new secondary carrier management to the receiver terminal.

### RRM-Primary and Secondary Carriers are Distinguished

In some embodiments, the first terminal transmits the measurement configurations and/or the measurement reports of at least two carriers to the second terminal.

The measurement configurations and/or the measurement reports are carried over each of the at least two carriers for independent transmission.

In some embodiments, the measurement configurations and/or the measurement reports are carried over the primary carrier for transmission. In the case of cross-carrier transmission of the measurement configurations and/or the measurement reports over the primary carrier, carriers corresponding to the measurement configurations and/or the measurement reports are indicated.

In some embodiments, the measurement configurations and/or the measurement reports are carried over a second carrier among the at least two carriers for transmission. In the case of cross-carrier transmission of the measurement configurations and/or the measurement reports over the second carrier, carriers corresponding to the measurement configurations and/or the measurement reports are indicated, wherein the second carrier is at least one secondary carrier selected from the at least two carriers.

The first terminal selects the second carrier from the at least two carriers based on at least one of the self-implementation, the third mapping rule, the third selection rule, or the third selection configuration.

The third mapping relationship is a mapping relationship for selecting a carrier for transmitting the measurement configuration and/or the measurement report. The third selection rule is a selection rule for selecting a carrier for transmitting the measurement configuration and/or the measurement report. The third selection configuration is a selection configuration for selecting a carrier for transmitting the measurement configuration and/or the measurement report.

### Embodiments of Primary Carrier RRM-Primary and Secondary Carriers are Distinguished

FIG. 20 is a schematic diagram of a method for measuring and configuring carriers according to some embodiments of the present disclosure. Description is given in the embodiments based on an example in which the method is applicable to a terminal. The method includes at least part of the following processes.

In process 2002, the first terminal transmits a measurement configuration of the primary carrier to the second terminal.

The first terminal transmits the measurement configuration of the primary carrier, that is, transmits the RRM measurement configuration of the primary carrier, wherein the RRM measurement mainly takes SSB and CSI-RS as reference signals. The SSB-based RRM measurement configuration includes configuration information such as an SSB frequency point, a measurement time configuration, or a reference signal configuration. The CSI-RS-based RRM configuration includes configuration information such as a time-domain or a frequency-domain position occupied by the CSI-RS resource, a sequence generation mode, or an associated SSB.

In some embodiments, the first terminal transmits the measurement configuration of the primary carrier to the second terminal over the primary carrier. In some embodiments, the second terminal transmits the measurement configuration of the primary carrier to the second terminal over a second carrier, wherein the second carrier is a selected carrier. In the case that the second carrier is a carrier selected by the first terminal, the first terminal indicates the second carrier to the second terminal in advance. In the case that the second carrier is a carrier selected by the network device, the network device indicates the second carrier to the first terminal and/or the second terminal in advance. In the case that the second carrier is a secondary carrier selected by the second terminal, the second terminal indicates the second carrier to the first terminal in advance.

In some embodiments, the first terminal is a transmitter terminal, and the second terminal is a receiver terminal; and/or the first terminal is a receiver terminal, and the second terminal is a transmitter terminal. In the case that the first terminal is a transmitter terminal, one or more second terminals are deployed.

In process 2004, the second terminal transmits a measurement report of the primary carrier to the first terminal.

The measurement report of the primary carrier includes a channel condition acquired by the second terminal upon measurement of a reference signal based on the measurement configuration of the primary carrier transmitted by the first terminal, which is transmitted by the second terminal to the first terminal.

In some embodiments, the measurement configuration of the primary carrier and/or the measurement report of the primary carrier are both carried over the primary carrier for transmission. Illustratively, as shown in FIG. 21, three available carriers are present between the terminal 1 and the terminal 2: carrier 1, carrier 2, and carrier 3, wherein the carrier 2 is a primary carrier. The terminal 1 transmits the measurement configuration corresponding to the carrier 2 to the terminal 2, and the measurement configuration of the carrier 2 is carried over the primary carrier (carrier 2) for transmission. Accordingly, the terminal 2 transmits a measurement report corresponding to the carrier 2 to the terminal 1, and the measurement report of the carrier 2 is carried over the primary carrier (carrier 2) for transmission. In the case that the measurement configuration and/or the measurement report of the primary carrier are transmitted over the primary carrier, the measurement configuration and/or the measurement report may indicate a carrier identifier of the primary carrier or may not indicate the carrier identifier of the primary carrier (implicit indication, no carrier identifier indicates the corresponding current carrier).

In some embodiments, the measurement configuration of the primary carrier and/or the measurement report of the primary carrier are carried over the second carrier for transmission.

In the case of cross-carrier transmission of the measurement configuration and/or the measurement report of the primary carrier over the second carrier, the primary carrier measured by the measurement configuration and/or the measurement report is indicated. That is, assuming that the second carrier is the i^{th} carrier among the at least two carriers, in the case of cross-carrier transmission of the measurement configuration and/or the measurement report of the primary carrier, the measurement configuration and/or the measurement report of the primary carrier are carried and transmitted over the i^{th} carrier, and the measurement configuration and/or the measurement report indicate the primary carrier. The i^{th} carrier is a carrier different from the primary carrier among the at least two carriers.

In some embodiments, taking an example where the i^{th} carrier is carrier i, the measurement configuration and/or the measurement report of the primary carrier are transmitted over the i^{th} carrier, and the measurement configuration and/or the measurement report indicate a carrier identifier of the primary carrier.

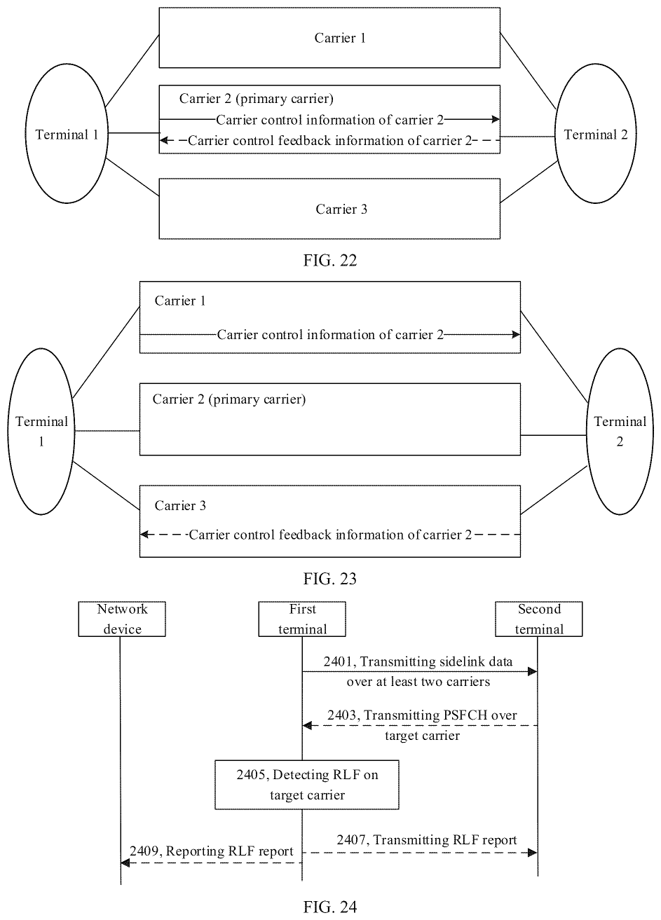

Illustratively, as shown in FIG. 22, three available carriers are present between the terminal 1 and the terminal 2: carrier 1, carrier 2, and carrier 3, wherein the carrier 2 is a primary carrier. The terminal 1 transmits the measurement configuration corresponding to the primary carrier to the terminal 2, the measurement configuration of the carrier 2 is carried over the carrier 1 for transmission, and the measurement configuration of the carrier 2 indicates the measured carrier 2. Accordingly, the terminal 2 transmits the measurement report corresponding to the carrier 2 to the terminal 1, the measurement report of the carrier 2 is carried over the carrier 1 or the carrier 3 for transmission, and the measurement report of the carrier 2 indicates the measured carrier 2. In some embodiments, the first terminal selects the second carrier based on self-implementation, and/or a third mapping relationship, and/or a third selection rule, and/or a third selection configuration. The third mapping relationship is a mapping relationship for selecting a carrier for transmitting the measurement configuration and/or the measurement report. The third selection rule is a selection rule for selecting a carrier for transmitting the measurement configuration and/or the measurement report. The third selection configuration is a selection configuration for selecting a carrier for transmitting the measurement configuration and/or the measurement report.

In some embodiments, the information used in the selection of the second carrier based on the self-implementation is pre-defined or pre-configured. In some embodiments, at least one of the third mapping relationship, the third selection rule, or the third selection configuration is pre-configured, or configured via the Uu interface, or configured via the PC5 interface. The self-implementation, the third mapping relationship, the third selection rule, and the third selection configuration may be used in combination or individually.

In some embodiments, the measurement configuration of the primary carrier is transmitted over the second carrier, the measurement configuration indicates the primary carrier, the measurement report is transmitted over the primary carrier, and the measurement report indicates the primary carrier or does not indicate the carrier identifier of the primary carrier.

In some embodiments, the measurement report of the primary carrier among the at least two carriers is transmitted over the second carrier, the measurement report indicates the primary carrier, the measurement configuration is transmitted over the primary carrier, and the measurement configuration indicates the primary carrier or does not indicate the carrier identifier of the primary carrier.

### Embodiments of Secondary Carrier RRM-Primary and Secondary Carriers are Distinguished

FIG. 23 is a schematic diagram of a method for measuring and configuring carriers according to some embodiments of the present disclosure. Description is given in the embodiments based on an example in which the method is applicable to a terminal. The method includes at least part of the following processes.

In process 2302, the first terminal transmits a measurement configuration of the secondary carrier to the second terminal.

The first terminal transmits the measurement configuration of the secondary carrier, that is, transmits the RRM measurement configuration of the secondary carrier, wherein the RRM measurement mainly takes SSB and CSI-RS as reference signals. The SSB-based RRM measurement configuration includes configuration information such as an SSB frequency point, a measurement time configuration, or a reference signal configuration. The CSI-RS-based RRM configuration includes configuration information such as a time-domain or a frequency-domain position occupied by the CSI-RS resource, a sequence generation mode, or an associated SSB.

In some embodiments, the first terminal transmits the measurement configuration of the secondary carrier independently to the second terminal over each of the at least two carriers. In some embodiments, the first terminal transmits the measurement configuration of the secondary carrier to the second terminal over the primary carrier. In some embodiments, the first terminal transmits the measurement configuration of the secondary carrier to the second terminal over the second carrier. The second carrier is one or more secondary carriers selected from the sidelink.

In some embodiments, the first terminal is a transmitter terminal, and the second terminal is a receiver terminal; and/or the first terminal is a receiver terminal, and the second terminal is a transmitter terminal. In the case that the first terminal is a transmitter terminal, one or more second terminals are deployed.

In process 2304, the second terminal transmits a measurement report of the secondary carrier to the first terminal.

The measurement report includes a channel condition acquired by the second terminal upon measurement of a reference signal based on the measurement configuration of the secondary carrier transmitted by the first terminal, which is transmitted to the first terminal by the second terminal.

In some embodiments, the measurement configuration and/or the measurement report of the secondary carrier are carried over each corresponding secondary carrier for independent transmission. In the case that the measurement configuration and/or the measurement report of the secondary carrier are transmitted over the corresponding secondary carrier, the measurement configuration and/or the measurement report may indicate a carrier identifier of the corresponding secondary carrier or may not indicate the carrier identifier of the corresponding secondary carrier (implicit indication, no carrier identifier indicates the corresponding current carrier).

In some embodiments, the measurement configuration and/or the measurement report of the secondary carrier are carried over the primary carrier for transmission. In the case of cross-carrier transmission of the measurement configuration and/or the measurement report of the secondary carrier over the primary carrier, the secondary carrier measured by the measurement configuration and/or the measurement report of the secondary carrier is indicated. That is, in the case of cross-carrier transmission of the measurement configuration and/or the measurement report of the secondary carrier, the measurement configuration and/or the measurement report of the i^{th} carrier are carried and transmitted over the primary carrier, and the measurement configuration and/or the measurement report indicate the i^{th} carrier. The i^{th} carrier is a carrier different from the primary carrier among the at least two carriers, and one or more i^{th} carriers may be present.

In some embodiments, taking an example where the i^{th} carrier is carrier i, the measurement configuration and/or the measurement report of the carrier i among the at least two carriers are transmitted over the primary carrier, and the measurement configuration and/or the measurement report indicate a carrier identifier of the carrier i. In the case that the measurement configuration and/or the measurement report of the secondary carrier are transmitted over the primary carrier, the measurement configuration and/or the measurement report indicate a carrier identifier of the secondary carrier.

In some embodiments, the measurement configuration and/or the measurement report of the secondary carrier are carried over a second carrier among the at least two carriers for transmission, and the second carrier is at least one secondary carrier among the at least two carriers. In the case of cross-carrier transmission of the measurement configuration and/or the measurement report of the secondary carrier over the second carrier, the secondary carrier measured by the measurement configuration and/or the measurement report is indicated. That is, in the case of cross-carrier transmission of the measurement configuration and/or the measurement report, the measurement configuration and/or the measurement report of the i^{th} carrier are carried and transmitted over the second carrier, and the measurement configuration and/or the measurement report indicate the i^{th} carrier. The i^{th} carrier is a secondary carrier different from the second carrier among the at least two carriers.

In some embodiments, the first terminal selects the second carrier based on self-implementation, and/or a third mapping relationship, and/or a third selection rule, and/or a third selection configuration. The third mapping relationship is a mapping relationship for a selecting carrier for transmitting the measurement configuration and/or the measurement report. The third selection rule is a selection rule for selecting a carrier for transmitting the measurement configuration and/or the measurement report. The third selection configuration is a selection configuration for selecting a carrier for transmitting the measurement configuration and/or the measurement report.

In some embodiments, the information used in the selection of the second carrier based on the self-implementation is pre-defined or pre-configured. In some embodiments, at least one of the third mapping relationship, the third selection rule, or the third selection configuration is pre-configured, or configured via the Uu interface, or configured via the PC5 interface. The self-implementation, the third mapping relationship, the third selection rule, or the third selection configuration may be used in combination or individually.

In some embodiments, taking an example where the i^{th} carrier is carrier i, the measurement configuration and/or the measurement report of the carrier i among the at least two carriers are transmitted over the second carrier, and the measurement configuration and/or the measurement report indicate a carrier identifier of the carrier i. In the case that the measurement configuration and/or the measurement report of the second carrier are transmitted over the second carrier, the measurement configuration and/or the measurement report may indicate a carrier identifier of the second carrier or may not indicate the carrier identifier of the second carrier (implicit indication, no carrier identifier indicates the corresponding current carrier).

In some embodiments, the measurement configuration of the secondary carrier is transmitted over the corresponding secondary carrier, the measurement report is transmitted over the primary carrier, and the measurement report indicates a secondary carrier corresponding to the measurement report.

In some embodiments, the measurement report of the secondary carrier is transmitted over the corresponding secondary carrier, the measurement configuration is transmitted over the primary carrier, and the measurement configuration indicates a secondary carrier corresponding to the measurement configuration.

In some embodiments, the measurement configuration of the secondary carrier is transmitted over the corresponding secondary carrier, the measurement report is transmitted over the second carrier, and the measurement report indicates a secondary carrier corresponding to the measurement report.

In some embodiments, the measurement report of the secondary carrier is transmitted over the corresponding secondary carrier, the measurement configuration is transmitted over the second carrier, and the measurement configuration indicates a secondary carrier corresponding to the measurement configuration.

In some embodiments, the measurement configuration of the secondary carrier is transmitted over the second carrier, and the measurement configuration indicates a secondary carrier; the measurement report is transmitted over the primary carrier, and the measurement report indicates a secondary carrier corresponding to the measurement report.

In some embodiments, the measurement report of the secondary carrier is transmitted over the second carrier, and the measurement report indicates a secondary carrier; the measurement configuration is transmitted over the primary carrier, and the measurement configuration indicates a secondary carrier corresponding to the measurement configuration.

### RLF Detection-Primary and Secondary Carriers are Distinguished

### Independent Detection of RLF on Each Carrier-Primary and Secondary Carriers are Distinguished

FIG. 24 is a schematic diagram of a method for detecting carrier RLF according to some embodiments of the present disclosure. Description is given in the embodiments based on an example in which the method is applicable to a terminal. The method includes at least part of the following processes.

In process 2401, the first terminal transmits a plurality of pieces of sidelink data to the second terminal over at least two carriers.

The first terminal independently transmits the sidelink data of each of the at least two carriers to the second terminal over each of the at least two carriers, that is, the first terminal transmits a PSSCH of the carrier i to the second terminal over the carrier i; or the first terminal transmits the PSSCH of the carrier i to the second terminal over the carrier i among the at least two carriers on the sidelink.

In some embodiments, the first terminal is a transmitter terminal, and the second terminal is a receiver terminal; and/or, the first terminal is a receiver terminal, and the second terminal is a transmitter terminal. In the case that the first terminal is a transmitter terminal, one or more second terminals are deployed.

In process 2403, the second terminal transmits a plurality of PSFCHs over a target carrier.

The second terminal transmits feedback information to the first terminal over the target carrier among the at least two carriers. The feedback information is used for feeding back whether the sidelink data of the carrier is correctly received. Illustratively, the feedback information is a PSFCH. In the case of correct reception, the feedback content of the feedback information may be ACK; and in the case of erroneous reception, the feedback content of the feedback information may be NACK.

In the embodiments, the target carrier is each of the at least two carriers. That is, the second terminal transmits the PSFCH of the carrier i to the first terminal over the carrier i among the at least two carriers on the sidelink.

In process 2405, the first terminal detects RLF on the target carrier.

The first terminal detects the PSFCH of a plurality of pieces of sidelink data transmitted by the second terminal over the target carrier.

In the embodiments, in the case that the target carrier is each of the at least two carriers, the first terminal performs independent detection or combined detection on the plurality of PSFCHs independently transmitted by the second terminal over each of the at least two carriers. The PSFCH on each carrier corresponds to the sidelink data on each carrier.

In some embodiments, the first terminal independently detects RLF for each of the at least two carriers, that is, independently detects the plurality of PSFCHs independently transmitted by the second terminal over each of the at least two carriers, and determines that an RLF has occurred on a seventh carrier in the case that the first terminal detects the loss of the PSFCHs for N consecutive pieces of sidelink data on the seventh carrier. The value of N is a default value, or a fixed value, or a value configured by the network, or a value configured by the second terminal, or a value autonomously determined by the first terminal. The seventh carrier is any one of the at least two carriers.

It should be noted that detecting the loss of the PSFCHs for N consecutive pieces of sidelink data on the seventh carrier includes: each of the N consecutive PSFCHs received on the seventh carrier being either lost or NACK.

In some embodiments, the first terminal performs combined detection of RLF on the at least two carriers, that is, performs combined detection on the plurality of PSFCHs independently transmitted by the second terminal over each of the at least two carriers. The first terminal determines that an RLF has occurred on the sidelink corresponding to the at least two carriers in the case that the first terminal detects the loss of the PSFCHs for M consecutive pieces of sidelink data on the at least two carriers. The PSFCHs of the M consecutive pieces of sidelink data may be carried over different carriers. That is, the RLF has occurred on the entire sidelink between the first terminal and the second terminal. The value of M is a default value, or a fixed value, or a value configured by the network, or a value configured by the second terminal, or a value autonomously determined by the first terminal.

It should be noted that detecting the loss of the PSFCHs for M consecutive pieces of sidelink data on the at least two carriers includes: each of the M consecutive PSFCHs cumulatively received on all of the at least two carriers being either lost or NACK.

Illustratively, three candidate carriers are present between the terminal 1 and the terminal 2: carrier 1, carrier 2, and carrier 3. The terminal 1 transmits a plurality of pieces of sidelink data to the terminal 2 over the three carriers, the terminal 2 transmits PSFCHs of the plurality of pieces of sidelink data to the terminal 1 over the three carriers, and the terminal 1 performs combined detection on the PSFCHs transmitted by the terminal 2 over the three carriers. In the case of detecting the loss or NACK of M consecutive PSFCHs on the carrier 1 and the carrier 3, the terminal 1 determines that an RLF has occurred on the sidelink corresponding to the three carriers, that is, the RLF has occurred on the entire sidelink between the terminal 1 and the terminal 2.

Typically, M is greater than N.

In some embodiments, the first terminal configures a mapping relationship between the sidelink data and the PSFCH for the second terminal; and/or, the first terminal receives the mapping relationship between the sidelink data and the PSFCH configured by the second terminal; and/or, the first terminal receives the mapping relationship between the sideline data and the PSFCH configured by the network device.

In process 2407, the first terminal transmits an RLF report to the second terminal in the case that an RLF has occurred on a carrier.

In the case that an RLF has occurred on one or more of the at least two carriers, the first terminal transmits an RLF report of the one or more carriers to the second terminal over the target carrier, i.e., each of the at least two carriers. In some embodiments, the RLF report is transmitted to the second terminal in an independent message form; or the RLF report of each of the at least two carriers is transmitted to the second terminal in a list form. The list includes the RLF report of each of the at least two carriers, wherein the RLF report of each of the at least two carriers is used for indicating whether RLF has occurred on the current carrier.

The RLF report is carried over PC5-RRC signaling, or MAC CE signaling, or physical layer signaling.

In process 2409, the first terminal reports an RLF report to the network device in the case that an RLF has occurred on a carrier.

In some embodiments, the first terminal is in a connected state and/or mode 1, and the network device supports sidelink CA, in the case that an RLF has occurred on one or more of the at least two carriers, the first terminal reports the RLF report of the one or more carriers to the network device over an uplink carrier. In some embodiments, the RLF report is reported to the network device in an independent message form; or the RLF report of each of the at least two carriers is reported to the network device in a list form. The list includes the RLF report of each of the at least two carriers, wherein the RLF report of each of the at least two carriers is used for indicating whether an RLF has occurred on the current carrier. The RLF report is carried over PC5-RRC signaling, or MAC CE signaling, or physical layer signaling.

In some embodiments, in the case that an RLF has occurred on the seventh carrier among the at least two carriers, or RLF has occurred on the seventh carrier and at least one carrier where RLF has not occurred is present, the first terminal performs carrier reselection.

In some embodiments, the first terminal disconnects the sidelink between the first terminal and the second terminal in the case that an RLF has occurred on all the carriers on the sidelink.

### Independent or Combined Detection of RLF on Primary Carrier-Primary and Secondary Carriers are Distinguished

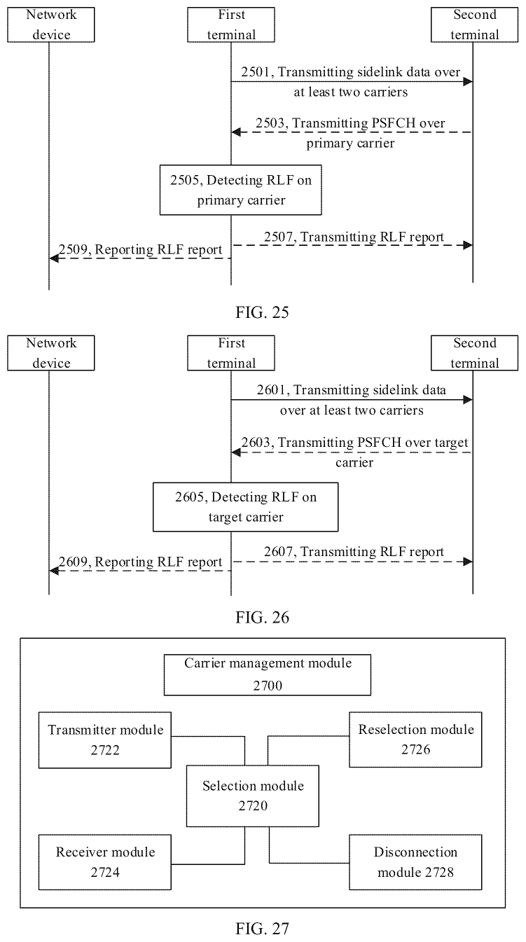

FIG. 25 is a schematic diagram of a method for detecting carrier RLF according to some embodiments of the present disclosure. Description is given in the embodiments based on an example in which the method is applicable to a terminal. The method includes at least part of the following processes.

In process 2501, the first terminal transmits a plurality of pieces of sidelink data to the second terminal over at least two carriers.

The first terminal independently transmits the sidelink data of the carrier to the second terminal over each of the at least two carriers, that is, the first terminal transmits the PSSCH of a carrier i to the second terminal over the carrier i.

In some embodiments, the first terminal is a transmitter terminal, and the second terminal is a receiver terminal; and/or, the first terminal is a receiver terminal, and the second terminal is a transmitter terminal. In the case that the first terminal is a transmitter terminal, one or more second terminals are deployed.

In process 2503, the second terminal transmits a plurality of PSFCHs over the primary carrier.

The second terminal transmits feedback information to the first terminal over the target carrier among the at least two carriers. The feedback information is used for feeding back whether the sidelink data of the carrier is correctly received, Illustratively, the feedback information is a PSFCH. In the case of correct reception, the feedback content of the feedback information may be ACK; and in the case of erroneous reception, the feedback content of the feedback information may be NACK.

In the embodiments, the target carrier is a primary carrier on the sidelink. That is, the second terminal transmits PSFCHs corresponding to sidelink data on different carriers to the first terminal over the primary carrier. The PSFCHs carry hybrid automatic repeat request (HARQ) information. In some embodiments, the plurality of PSFCHs have a mapping relationship with the plurality of PSSCHs, and prior to transmitting the PSFCHs, the mapping relationship is configured by the first terminal for the second terminal, or configured by the network device for the first terminal and the second terminal, or configured by the second terminal for the first terminal.

In process 2505, the first terminal detects RLF on the primary carrier.

The first terminal detects the PSFCH of a plurality of pieces of sidelink data transmitted by the second terminal over the target carrier.

In the embodiments, the target carrier is a primary carrier on the sidelink, the first terminal performs independent detection or combined detection on the plurality of PSFCHs transmitted by the second terminal over the primary carrier, and the plurality of PSFCHs have a mapping relationship with the sidelink data on the at least two carriers.

In some embodiments, the first terminal independently detects the RLF on the PSFCH of each carrier transmitted over the primary carrier, that is, independently detects the plurality of PSFCHs transmitted over the primary carrier by the second terminal, and determines that an RLF has occurred on the seventh carrier in the case that the first terminal detects the loss of the PSFCHs for N consecutive pieces of sidelink data corresponding to the seventh carrier on the primary carrier. The value of N is a default value, or a fixed value, or a value configured by the network, or a value configured by the second terminal, or a value autonomously determined by the first terminal. The seventh carrier is one of the at least two carriers.

It should be noted that detecting the loss of the PSFCHs for N consecutive pieces of sidelink data corresponding to the seventh carrier on the primary carrier includes: each of the N consecutive PSFCHs corresponding to the seventh carrier being either lost or NACK.

In some embodiments, the first terminal performs combined detection of RLF on the primary carrier, that is, performs combined detection on the plurality of PSFCHs transmitted by the second terminal over the primary carrier, and in the case that the first terminal detects the loss of the PSFCHs for M consecutive pieces of sidelink data on the primary carrier, the first terminal determines that an RLF has occurred on the sidelink corresponding to the primary carrier, that is, the RLF has occurred on the entire sidelink between the first terminal and the second terminal. The value of M is a default value, or a fixed value, or a value configured by the network, or a value configured by the second terminal, or a value autonomously determined by the first terminal.

It should be noted that detecting the loss of the PSFCHs for M consecutive pieces of sidelink data on the primary carrier includes: each of the M consecutive PSFCHs cumulatively received on the primary carrier being either lost or NACK.

Illustratively, three candidate carriers are present between the terminal 1 and the terminal 2: carrier 1, carrier 2, and carrier 3, wherein the carrier 2 is a primary carrier. The terminal 1 transmits a plurality of pieces of sidelink data to the terminal 2 over the three carriers, the terminal 2 transmits PSFCHs of the plurality of pieces of sidelink data to the terminal 1 over the carrier 2, and the terminal 1 performs combined detection on the PSFCHs transmitted by the terminal 2 on the carrier 2. In the case of detecting the loss or NACK of M consecutive PSFCHs on the carrier 2, the terminal 1 determines that an RLF has occurred on the sidelink corresponding to the primary carriers, that is, the RLF has occurred on the entire sidelink between the terminal 1 and the terminal 2.

Typically, M is greater than N.

In some embodiments, the first terminal configures a mapping relationship between the sidelink data and the PSFCH for the second terminal; and/or the first terminal receives the mapping relationship between the sidelink data and the PSFCH configured by the second terminal; and/or the first terminal receives the mapping relationship between the sideline data and the PSFCH configured by the network device.

In process 2507, the first terminal transmits an RLF report to the second terminal in the case that an RLF has occurred on a carrier.

In some embodiments, in the case that an RLF has occurred on one or more of the at least two carriers, the first terminal transmits an RLF report of the one or more carriers to the second terminal over the target carrier, i.e., the primary carrier. In some embodiments, the RLF report is transmitted to the second terminal in an independent message form; or the RLF report of each of the at least two carriers is transmitted to the second terminal in a list form. The list includes the RLF report of each of the at least two carriers, wherein the RLF report of each of the at least two carriers is used for indicating whether an RLF has occurred on the current carrier.

The RLF report is carried over PC5-RRC signaling, or MAC CE signaling, or physical layer signaling.

In process 2509, the first terminal reports an RLF report to the network device in the case that an RLF has occurred on a carrier.

In some embodiments, the first terminal is in a connected state and/or mode 1, and the network device supports sidelink CA, in the case that an RLF has occurred on one or more of the at least two carriers, the first terminal reports the RLF report of the one or more carriers to the network device over an uplink carrier. In some embodiments, the RLF report is reported to the network device in an independent message form; or the RLF report of each of the at least two carriers is reported to the network device in a list form. The list includes the RLF report of each of the at least two carriers, wherein the RLF report of each of the at least two carriers is used for indicating whether RLF has occurred on the current carrier.

The RLF report is carried over PC5-RRC signaling, or MAC CE signaling, or physical layer signaling.

In some embodiments, in the case that an RLF has occurred on the seventh carrier among the at least two carriers, or RLF has occurred on the seventh carrier and at least one carrier where RLF has not occurred is present, the first terminal performs carrier reselection.

In some embodiments, the first terminal disconnects the sidelink between the first terminal and the second terminal in the case that an RLF has occurred on the sidelink.

### Independent or Combined Detection of RLF on Secondary Carrier-Primary and Secondary Carriers are Distinguished

FIG. 26 is a schematic diagram of a method for detecting carrier RLF according to some embodiments of the present disclosure. description is given in the embodiments based on an example in which the method is applicable to a terminal. The method includes at least part of the following processes.

In process 2601, the first terminal transmits a plurality of pieces of sidelink data to the second terminal over at least two carriers.

The first terminal independently transmits the sidelink data of the carrier to the second terminal over each of the at least two carriers, that is, the first terminal independently transmits the sidelink data PSSCH of the carrier i to the second terminal over the carrier i among the at least two carriers, wherein the carrier i is a non-primary carrier among the at least two carriers.

In some embodiments, the first terminal is a transmitter terminal, and the second terminal is a receiver terminal; and/or, the first terminal is a receiver terminal, and the second terminal is a transmitter terminal. In the case that the first terminal is a transmitter terminal, one or more second terminals are deployed.

In process 2603, the second terminal transmits a plurality of PSFCHs over a target carrier.

The second terminal transmits feedback information to the first terminal over the target carrier among the at least two carriers. The feedback information is used for feeding back whether the sidelink data of the carrier is correctly received. Illustratively, the feedback information is a PSFCH. In the case of correct reception, the feedback content of the feedback information may be ACK; and in the case of erroneous reception, the feedback content of the feedback information may be NACK.

In the embodiments, the target carrier is a sixth carrier among the at least two carriers, and the sixth carrier is at least one secondary carrier among the at least two carriers.

In some embodiments, the first terminal selects the sixth carrier based on self-implementation, and/or a fifth mapping relationship, and/or a fifth selection rule, and/or a fifth selection configuration. The fifth mapping relationship is a mapping relationship for selecting a secondary carrier for transmitting the PSFCH. The fifth selection rule is a selection rule for selecting a secondary carrier for transmitting the PSFCH. The fifth selection configuration is a selection configuration for selecting a secondary carrier for transmitting the PSFCH.

In some embodiments, the information used in the selection of the sixth carrier based on the self-implementation is pre-defined or pre-configured. In some embodiments, at least one of the fifth mapping relationship, the fifth selection rule, or the fifth selection configuration is pre-configured, or configured via the Uu interface, or configured via the PC5 interface. The self-implementation, the fifth mapping relationship, the fifth selection rule, and the fifth selection configuration may be used in combination or individually.

In some embodiments, the first terminal transmits the indication information of the sixth carrier to the second terminal, or the first terminal receives the indication information of the sixth carrier from the second terminal, or the first terminal receives the indication information of the sixth carrier from the network device.

In process 2605, the first terminal detects RLF over the target carrier.

The first terminal detects the PSFCH of a plurality of pieces of sidelink data transmitted by the second terminal over the target carrier.

The target carrier is a sixth carrier among the at least two carriers, the first terminal performs independent detection or combined detection on the plurality of PSFCHs transmitted by the second terminal over the sixth carrier, and the plurality of PSFCHs have a mapping relationship with the sidelink data on the at least two carriers.

In some embodiments, the first terminal independently detects the RLF on the PSFCH of each carrier transmitted over the sixth carrier, that is, independently detects the plurality of PSFCHs corresponding to each carrier transmitted by the second terminal over the sixth carrier, and determines that an RLF has occurred on the seventh carrier in the case that the first terminal detects the loss of the PSFCHs for N consecutive pieces of sidelink data corresponding to the seventh carrier on the sixth carrier. The value of N is a default value, or a fixed value, or a value configured by the network, or a value configured by the second terminal, or a value autonomously determined by the first terminal. The seventh carrier is one of the at least two carriers.

It should be noted that detecting the loss of the PSFCHs of N consecutive pieces of sidelink data corresponding to the seventh carrier on the sixth carrier includes: each of the N consecutive PSFCHs corresponding to the seventh carrier received on the sixth carrier being either lost or NACK.

In some embodiments, the first terminal performs combined detection of RLF on the sixth carrier, that is, performs combined detection on the plurality of PSFCHs transmitted by the second terminal over the sixth carrier, and in the case that the first terminal detects the loss of the PSFCHs for M consecutive pieces of sidelink data on the sixth carrier, the first terminal determines that an RLF has occurred on the sidelink corresponding to the at least two carriers, that is, the RLF has occurred on the entire sidelink between the first terminal and the second terminal. The value of M is a default value, or a fixed value, or a value configured by the network, or a value configured by the second terminal, or a value autonomously determined by the first terminal.

It should be noted that detecting the loss of the PSFCHs for M consecutive pieces of sidelink data on the sixth carrier includes: each of the M consecutive PSFCHs cumulatively received on the sixth carrier being either lost or NACK.

Illustratively, three candidate carriers are present between the terminal 1 and the terminal 2: carrier 1, carrier 2, and carrier 3, wherein the carrier 2 is the sixth carrier. The terminal 1 transmits a plurality of pieces of sidelink data to the terminal 2 over the three carriers, the terminal 2 transmits PSFCHs of the plurality of pieces of sidelink data to the terminal 1 over the carrier 2, and the terminal 1 performs combined detection on the PSFCHs transmitted by the terminal 2 over the carrier 2. In the case of detecting the loss or NACK of M consecutive PSFCHs on the carrier 2, the terminal 1 determines that an RLF has occurred on the sidelink corresponding to the primary carriers, that is, the RLF has occurred on the entire sidelink between the terminal 1 and the terminal 2.

Typically, M is greater than N.

In some embodiments, the first terminal configures a mapping relationship between the sidelink data and the PSFCH for the second terminal; and/or the first terminal receives the mapping relationship between the sidelink data and the PSFCH configured by the second terminal; and/or the first terminal receives the mapping relationship between the sideline data and the PSFCH configured by the network device.

In process 2607, the first terminal transmits an RLF report to the second terminal in the case that an RLF has occurred on a carrier.

In some embodiments, in the case that an RLF has occurred on one or more of the at least two carriers, the first terminal transmits an RLF report of the one or more carriers to the second terminal over the target carrier, i.e., the sixth carrier. In some embodiments, the RLF report is transmitted to the second terminal in an independent message form; or the RLF report of each of the at least two carriers is transmitted to the second terminal in a list form. The list includes the RLF report of each of the at least two carriers, wherein the RLF report of each of the at least two carriers is used for indicating whether RLF has occurred on the current carrier.

The RLF report is carried over PC5-RRC signaling, or MAC CE signaling, or physical layer signaling.

In process 2609, the first terminal reports an RLF report to the network device in the case that an RLF has occurred on a carrier.

In some embodiments, the first terminal is in a connected state and/or mode 1, and the network device supports sidelink CA, in the case that an RLF has occurred on one or more of the at least two carriers, the first terminal reports the RLF report of the one or more carriers to the network device over an uplink carrier. In some embodiments, the RLF report is reported to the network device in an independent message form; or the RLF report of each of the at least two carriers is reported to the network device in a list form. The list includes the RLF report of each of the at least two carriers, wherein the RLF report of each of the at least two carriers is used for indicating whether RLF has occurred on the current carrier.

The RLF report is carried over PC5-RRC signaling, or MAC CE signaling, or physical layer signaling.

In some embodiments, in the case that an RLF has occurred on the seventh carrier among the at least two carriers, or RLF has occurred on the seventh carrier and at least one carrier where RLF has not occurred is present, the first terminal performs carrier reselection.

In some embodiments, the first terminal disconnects the sidelink between the first terminal and the second terminal in the case that an RLF has occurred on the sidelink.

### RLF Recovery-Primary and Secondary Carriers are Distinguished

According to some embodiments of the present disclosure, a method for recovering carriers is provided. Description is given in the embodiments based on an example in which the method is applicable to a terminal.

In some embodiments, the first terminal independently performs RLF detection on each carrier on the sidelink. In the case that an RLF has occurred on a non-primary carrier among non-primary carriers on the sidelink, or RLF has occurred on a non-primary carrier and at least one carrier where RLF has not occurred is present, the first terminal performs carrier reselection; and/or the first terminal disconnects the current sidelink between the first terminal and the second terminal in the case that an RLF has occurred on the sidelink.

In some embodiments, the first terminal performs RLF detection on the primary carrier. In the case that an RLF has occurred on the primary carrier, or an RLF has occurred on the primary carrier and one secondary carrier where an RLF has not occurred is present, the first terminal performs carrier reselection; and/or in the case that an RLF has occurred on the primary carrier, the first terminal disconnects the current sidelink between the first terminal and the second terminal.

It should be understood that the above-described methods for selecting carriers in the sidelink may be used alone or in combination.

FIG. 27 is a structural block diagram of an apparatus for selecting carriers according to some embodiments of the present disclosure. The apparatus includes at least part of a carrier management module 2700.

The carrier management module 2700 is configured to perform carrier management on at least two carriers with a second terminal in CA-based sidelink communication.

In some embodiments, the at least two carriers are not distinguished as primary and secondary carriers, or the at least two carriers have the same status.

In some embodiments, the carrier management module 2700 includes: a selection module 2720, configured to select, with/without the second terminal, the at least two carriers based on at least one of self-implementation, a first mapping relationship, a first selection rule, or a first selection configuration.

The first mapping relationship is a mapping relationship for selecting a carrier for CA. The first selection rule is a selection rule for selecting a carrier for CA. The first selection configuration is a selection configuration for selecting a carrier for CA.

In some embodiments, the at least two carriers are selected by the selection module 2720 based on at least one of: a service type; an application type; a data transmission type; a transmission attribute; QoS; a layer 2 ID; a logical channel mapping; a resource pool; a radio bearer; a resource pool congestion degree; a data priority; or link quality or channel condition of a candidate carrier.

In some embodiments, the first terminal independently transmits carrier configuration information over each of the at least two carriers.

In some embodiments, the carrier management module 2700 further includes a transmitter module 2722. The transmitter module 2722 transmits carrier control information to the second terminal over a sidelink message, wherein the carrier control information is used for performing at least one of an add operation, a delete operation, or a modify operation on the at least two carriers.

In some embodiments, the apparatus is a transmitter terminal or a receiver terminal.

In some embodiments, the carrier control information is generated by the carrier management module 2700; or the carrier control information is configured by the network device for a receiver module 2724.

In some embodiments, the carrier control information is carried over each of the at least two carriers for independent transmission; or the carrier control information is carried over a first carrier among the at least two carriers for transmission, and the carrier control information indicates a carrier controlled by the carrier control information in the case of cross-carrier transmission of the carrier control information over the first carrier.

The first carrier is at least one carrier selected by the selection module 2720 from the at least two carriers.

In some embodiments, the selection module 2720 selects the first carrier from the at least two carriers based on at least one of self-implementation, a second mapping relationship, a second selection rule, or a second selection configuration.

The second mapping relationship is a mapping relationship for selecting to transmit the carrier control information. The second selection rule is a selection rule for selecting to transmit the carrier control information. The second selection configuration is a selection configuration for selecting to transmit the carrier control information.

In some embodiments, the sidelink message is PC5-RRC signaling, MAC CE signaling, or physical layer signaling.

In some embodiments, the transmitter module 2722 is configured to transmit the measurement configurations and/or the measurement reports of the at least two carriers to the second terminal.

In some embodiments, the measurement configurations and/or the measurement reports are carried over each of the at least two carriers and are independently transmitted by the transmitter module 2722 to the second terminal; or the measurement configurations and/or the measurement reports are carried over the second carrier among the at least two carriers and are transmitted by the transmitter module 2722 to the second terminal. In the case of cross-carrier transmission of the measurement configurations and/or the measurement reports over the second carrier, carriers corresponding to the measurement configurations and/or the measurement reports are indicated.

The second carrier is at least one carrier selected by the selection module 2720 from the at least two carriers.

In some embodiments, the selection module 2720 is configured to select the second carrier from the at least two carriers based on at least one of self-implementation, a third mapping rule, a third selection rule, or a third selection configuration.

The third mapping relationship is a mapping relationship for selecting a carrier for transmitting the measurement configuration and/or the measurement report. The third selection rule is a selection rule for selecting a carrier for transmitting the measurement configuration and/or the measurement report. The third selection configuration is a selection configuration for selecting a carrier for transmitting the measurement configuration and/or the measurement report.

In some embodiments, the transmitter module 2722 is configured to transmit a plurality of pieces of sidelink data to the second terminal over the at least two carriers. The carrier management module 2700 further includes a receiver module 2724. The receiver module 2724 is configured to detect a plurality of PSFCHs transmitted by the second terminal over the target carrier, wherein the plurality of PSFCHs carry the feedback information of the plurality of pieces of sidelink data, the target carrier is each of the at least two carriers or a third carrier, wherein the third carrier is at least one carrier selected by the selection module 2720 from the at least two carriers. The transmitter module 2722 is configured to transmit an RLF report to the second terminal over the target carrier and/or transmit an RLF report to the network device over an uplink carrier in the case that the detection result indicates that an RLF has occurred.

In some embodiments, the target carrier is each of the at least two carriers.

The receiver module 2724 is configured to: independently detect a plurality of PSFCHs that are independently transmitted by the second terminal over each of the at least two carriers, wherein the PSFCH on each of the at least two carriers corresponds to the sidelink data on each of the at least two carriers; and determine that an RLF has occurred on the fourth carrier In the case that the loss of the PSFCHs for N consecutive pieces of sidelink data is detected on a fourth carrier.

The fourth carrier is one of the at least two carriers.

In some embodiments, the target carrier is each of the at least two carriers. The receiver module 2724 is configured to: perform combined detection on a plurality of PSFCHs that are independently transmitted by the second terminal over each of the at least two carriers, wherein the PSFCH on each of the at least two carriers corresponds to the sidelink data on each of the at least two carriers; and determine that an RLF has occurred on the sidelink corresponding to the at least two carriers in the case that the loss of the PSFCHs for M consecutive pieces of sidelink data is detected on the at least two carriers.

In some embodiments, the target carrier is a third carrier among the at least two carriers.

The receiver module 2724 is configured to: detect a plurality of PSFCHs transmitted by the second terminal over the third carrier, wherein the plurality of PSFCHs have a mapping relationship with the plurality of pieces of sidelink data on the at least two carriers; and determine that an RLF has occurred on the fourth carrier in the case that the loss of the PSFCHs for N consecutive pieces of sidelink data corresponding to the fourth carrier is detected on the third carrier.

The fourth carrier is one of the at least two carriers.

In some embodiments, the target carrier is a third carrier among the at least two carriers.

In some embodiments, the receiver module 2724 is configured to: perform combined detection on a plurality of PSFCHs transmitted by the second terminal over the third carrier, wherein the plurality of PSFCHs have a mapping relationship with the plurality of pieces of sidelink data on the at least two carriers; and determine that an RLF has occurred on the sidelink corresponding to the at least two carriers in the case that the loss of the PSFCHs for M consecutive pieces of sidelink data is detected on the third carrier.

In some embodiments, the apparatus further includes: a transmitter module 2722 or a receiver module 2724.

The transmitter module 2722 is configured to configure the mapping relationship between the sidelink data and the PSFCH for the second terminal; or the receiver module 2724 is configured to receive the mapping relationship between the sidelink data and the PSFCH configured by the second terminal; or the receiver module 2724 is configured to receive the mapping relationship between the sidelink data and the PSFCH configured by the network device.

In some embodiments, N is defined for a single carrier.

N is a default value, or a fixed value, or a value configured by the network device, or a value autonomously determined by the apparatus, or a value configured by the second terminal.

In some embodiments, M is defined for the sidelink to which the at least two carriers belong.

M is a default value, or a fixed value, or a value configured by the network device, or a value autonomously determined by the apparatus, or a value configured by the second terminal.

In some embodiments, the selection module 2720 is further configured to select the third carrier from the at least two carriers based on at least one of self-implementation, a fourth mapping relationship, a fourth selection rule, or a fourth selection configuration. The transmitter module 2722 is further configured to transmit the indication information of the third carrier to the second terminal. The receiver module 2724 is further configured to receive the indication information of the third carrier from the second terminal, or the receiver module 2724 is further configured to receive the indication information of the third carrier from the network device.

The fourth mapping relationship is a mapping relationship for selecting a carrier for transmitting the PSFCH. The fourth selection rule is a selection rule for selecting a carrier for transmitting the PSFCH. The fourth selection configuration is a selection configuration for selecting a carrier for transmitting the PSFCH.

In some embodiments, the carrier management module 2700 further includes: a reselection module 2726, configured to perform carrier reselection in the case that an RLF has occurred on the fourth carrier; or the reselection module 2726 is further configured to perform carrier reselection in the case that an RLF has occurred on the fourth carrier and at least one carrier where RLF has not occurred is present.

In some embodiments, the carrier management module 2700 further includes: a disconnection module 2728, configured to disconnect the sidelink between the first terminal and the second terminal in the case that an RLF has occurred on the sidelink.

In some embodiments, the at least two carriers are distinguished as primary and secondary carriers.

In some embodiments, the primary carrier is a carrier used by the transmitter module 2722 to transmit a first message to the receiver terminal; or the primary carrier is a carrier corresponding to a logical channel with the highest priority; or the primary carrier is a carrier with the lowest CBR measurement value in an available carrier set; or, the primary carrier is a carrier with the best channel quality in an available carrier set; or the primary carrier is a carrier suggested/configured by the second carrier; or the primary carrier is a carrier configured by the network device.

In some embodiments, the first message includes at least one of: a discovery message; a direct communication request (DCR) message; a first piece of data information; or a first piece of PC5-RRC information.

In some embodiments, the carrier management module 2700 includes: a transmitter module 2722, configured to transmit a primary carrier configuration to the second terminal.

In some embodiments, the carrier management module 2700 includes: a receiver module 2724, configured to receive a first response message for the primary carrier configuration from the second terminal.

In some embodiments, the carrier management module 2700 is configured to perform sidelink communication with the second terminal over the primary carrier in the case that the first response message indicates a configuration acceptance.

In some embodiments, the carrier management module 2700 is configured to perform sidelink communication with the second terminal using a default or pre-configured or arbitrary carrier as the primary carrier in the case that the first response message indicates a configuration rejection.

In some embodiments, the transmitter module 2722 is configured to transmit a primary carrier change indication to the second terminal, wherein the primary carrier change indication is used to change the primary carrier.

In some embodiments, the primary carrier change indication is transmitted in at least one of: a periodically triggered mode; or an event-triggered mode.

In some embodiments, the event includes at least one of the following items:
an RLF occurs on the primary carrier prior to change;
the receiver module 2724 receives an RLF report from the second terminal, wherein the RLF report indicates that an RLF has occurred on the primary carrier prior to change;
the CBR value on the primary carrier prior to change is greater than a threshold;
the primary carrier prior to change is not in the configured available carrier set;
the receiver module 2724 receives a request from the second terminal; or
the receiver module 2724 receives a change indication from the network device.

In some embodiments, the primary carrier change indication is carried over the primary carrier prior to change and transmitted by the transmitter module 2722 to the second terminal, wherein the primary carrier change indication carries an indication of the changed primary carrier.

In some embodiments, the primary carrier change indication is carried over the changed primary carrier and transmitted by the transmitter module 2722 to the second terminal, wherein the primary carrier change indication carries an indication that the current carrier is the primary carrier.

In some embodiments, the primary carrier change indication is carried over a sixth carrier and transmitted by the transmitter module 2722 to the second terminal, wherein the sixth carrier is any one or more active carriers in the sidelink.

In some embodiments, the receiver module 2724 is configured to receive a second response message for the primary carrier change indication from the second terminal. In the case that the second response message indicates a change acceptance, the carrier management module 2700 performs sidelink communication with the second terminal over the changed primary carrier.

In some embodiments, the carrier management module 2700 is configured to perform sidelink communication with the second terminal using a default or unchanged or arbitrary carrier as the primary carrier in the case that the second response message indicates a change rejection.

In some embodiments, the transmitter module 2722 is configured to transmit a secondary carrier configuration to the second terminal, wherein the secondary carrier configuration is used for instructing to perform at least one of an add operation, a delete operation, or a modify operation on the secondary carrier.

In some embodiments, the secondary carrier configuration is carried over the primary carrier for transmission.

In some embodiments, the secondary carrier configuration is carried over PC5-RRC signaling, MAC CE signaling, or physical layer signaling.

In some embodiments, the transmitter module 2722 is configured to transmit an activation indication of a first secondary carrier to the second terminal.

In some embodiments, the transmitter module 2722 is configured to activate the first secondary carrier in response to expiration of a first timer. The first timer starts timing from the receiving moment or the transmitting moment of the last deactivation indication.

In some embodiments, the transmitter module 2722 is configured to transmit a deactivation indication of a second secondary carrier to the second terminal.

In some embodiments, the transmitter module 2722 is configured to deactivate the second secondary carrier in response to expiration of a second timer. The second timer starts timing from the receiving moment or the transmitting moment of the last activation indication.

In some embodiments, the timing value of the first timer is pre-configured, or configured by the network device, or autonomously determined by the carrier management module 2700, or configured by the second terminal.

The timing value of the second timer is pre-configured, or configured by the network device, or autonomously determined by the carrier management module 2700, or configured by the second terminal.

In some embodiments, the transmitter module 2722 is configured to transmit a plurality of pieces of sidelink data to the second terminal over the at least two carriers. The receiver module 2724 is configured to detect a plurality of PSFCHs transmitted by the second terminal over a target carrier, wherein the plurality of PSFCHs carry the feedback information of the plurality of pieces of sidelink data, the target carrier is each of the at least two carriers or the primary carrier or a sixth carrier, wherein the sixth carrier is at least one secondary carrier selected by the selection module 2720 from the at least two carriers. The transmitter module 2722 is configured to transmit an RLF report to the second terminal over the primary carrier and/or transmit an RLF report to the network device over an uplink carrier in the case the detection result indicates that an RLF has occurred.

In some embodiments, the target carrier is each of the at least two carriers.

The receiver module 2724 is configured to: independently detect a plurality of PSFCHs that are independently transmitted by the second terminal over each of the at least two carriers, wherein the PSFCH on each of the at least two carriers corresponds to the sidelink data on each of the at least two carriers; and determine that an RLF has occurred on the seventh carrier in the case that the loss of the PSFCHs for N consecutive pieces of sidelink data is detected on a seventh carrier.

The seventh carrier is one of the at least two carriers.

In some embodiments, the target carrier is each of the at least two carriers.

The receiver module 2724 is configured to: perform combined detection on a plurality of PSFCHs that are independently transmitted by the second terminal over each of the at least two carriers, wherein the PSFCH on each of the at least two carriers corresponds to the sidelink data on each of the at least two carriers; and determine that an RLF has occurred on the sidelink corresponding to the at least two carriers in the case that the loss of the PSFCHs for M consecutive pieces of sidelink data is detected on the at least two carriers.

In some embodiments, the target carrier is the primary carrier.

The receiver module 2724 is configured to: detect a plurality of PSFCHs transmitted by the second terminal over the primary carrier, wherein the plurality of PSFCHs have a mapping relationship with the plurality of pieces of sidelink data on the at least two carriers; and determine that an RLF has occurred on the seventh carrier in the case that the loss of N consecutive PSFCHs corresponding to the seventh carrier is detected on the primary carrier.

In some embodiments, the target carrier is the primary carrier.

The receiver module 2724 is configured to: detect a plurality of PSFCHs transmitted by the second terminal over the primary carrier, wherein the plurality of PSFCHs have a mapping relationship with the plurality of pieces of sidelink data on the at least two carriers; and determine that an RLF has occurred on the sidelink corresponding to the at least two carriers in the case that the loss of the PSFCHs for M consecutive pieces of sidelink data is detected on the primary carrier.

In some embodiments, the target carrier is the sixth carrier.

The receiver module 2724 is configured to: detect a plurality of PSFCHs transmitted by the second terminal over the sixth carrier, wherein the plurality of PSFCHs have a mapping relationship with the plurality of pieces of sidelink data on the at least two carriers; and determine that an RLF has occurred on the seventh carrier in the case that the loss of N consecutive PSFCHs corresponding to the seventh carrier is detected on the sixth carrier.

In some embodiments, the target carrier is the sixth carrier.

The receiver module 2724 is configured to: detect a plurality of PSFCHs transmitted by the second terminal over the sixth carrier, wherein the plurality of PSFCHs have a mapping relationship with the plurality of pieces of sidelink data on the at least two carriers; and determine that an RLF has occurred on the sidelink corresponding to the at least two carriers in the case that the loss of the PSFCHs for M consecutive pieces of sidelink data is detected on the sixth carrier.

In some embodiments, the transmitter module 2722 is further configured to configure the mapping relationship between the sidelink data and the PSFCH for the second terminal;

In some embodiments, the receiver module 2724 is further configured to receive the mapping relationship between the sidelink data and the PSFCHs configured by the second terminal; or the receiver module 2724 is further configured to receive the mapping relationship between the sidelink data and the PSFCH configured by the network device.

In some embodiments, N is defined for a single carrier.

N is a default value, or a fixed value, or a value configured by the network device, or a value autonomously determined by the carrier management module 2700, or a value configured by the second terminal.

In some embodiments, M is defined for the sidelink to which the at least two carriers belong.

M is a default value, or a fixed value, or a value configured by the network device, or a value autonomously determined by the carrier management module 2700, or a value configured by the second terminal.

In some embodiments, the selection module 2720 is configured to select the sixth carrier from the at least two carriers based on at least one of self-implementation, a fifth mapping rule, a fifth selection rule, or a fifth selection configuration; and the transmitter module 2722 is configured to transmit the indication information of the sixth carrier to the second terminal.

In some embodiments, the receiver module 2724 is configured to receive the indication information of the sixth carrier from the second terminal; or the receiver module 2724 is configured to receive the indication information of the sixth carrier from the network device.

The fifth mapping relationship is a mapping relationship for selecting a secondary carrier for transmitting the PSFCH. The fifth selection rule is a selection rule for selecting a secondary carrier for transmitting the PSFCH. The fifth selection configuration is a selection configuration for selecting a secondary carrier for transmitting the PSFCH.

In some embodiments, the carrier management module 2700 includes: a reselection module 2726, configured to perform carrier reselection in the case that an RLF has occurred on the seventh carrier; or a reselection module 2726, configured to perform carrier reselection in the case that an RLF has occurred on the seventh carrier and at least one carrier where RLF has not occurred is present.

In some embodiments, the carrier management module 2700 includes: a disconnection module 2728, configured to disconnect the sidelink between the first terminal and the second terminal in the case that an RLF has occurred on the sidelink.

In some embodiments, the carrier management module 2700 includes: a transmitter module 2722.

The transmitter module 2722 is configured to transmit measurement configurations and/or measurement reports of the at least two carriers to the second terminal.

In some embodiments, the measurement configurations and/or the measurement reports are carried over each of the at least two carriers for independent transmission; or

In some embodiments, the measurement configurations and/or the measurement reports are carried over the primary carrier for transmission. In the case of cross-carrier transmission of the measurement configurations and/or the measurement reports over the primary carrier, carriers corresponding to the measurement configurations and/or the measurement reports are indicated.

In some embodiments, the measurement configurations and/or the measurement reports are carried over a second carrier among the at least two carriers for transmission. In the case of cross-carrier transmission of the measurement configurations and/or the measurement reports over the second carrier, carriers corresponding to the measurement configurations and/or the measurement reports are indicated.

The second carrier is at least one secondary carrier selected by the selection module 2720 from the at least two carriers.

In some embodiments, the selection module 2720 is configured to select the second carrier from the at least two carriers based on at least one of self-implementation, a third mapping rule, a third selection rule, or a third selection configuration.

The third mapping relationship is a mapping relationship for selecting a carrier for transmitting the measurement configuration and/or the measurement report. The third selection rule is a selection rule for selecting a carrier for transmitting the measurement configuration and/or the measurement report. The third selection configuration is a selection configuration for selecting a carrier for transmitting the measurement configuration and/or the measurement report.

It should be noted that, for the apparatus according to the embodiments described above, the division of the functional modules is merely exemplary. In practice, the functions described above may be assigned to and completed by different functional modules as needed, that is, the internal structure of the apparatus may be divided into different functional modules, to implement all or a part of the above functions.

With regard to the apparatus in the embodiments, the specific manner in which each module performs the operation has been described in detail in the embodiments related to the method and will not be described in detail herein.

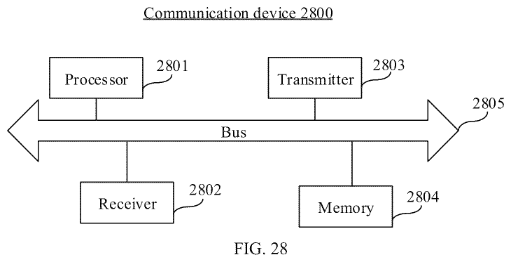

FIG. 28 is a schematic structural diagram of a communication device (a terminal device or a network device) according to some exemplary embodiments of the present disclosure. The communication device 2800 includes: a processor 2801, a receiver 2802, a transmitter 2803, a memory 2804, and a bus 2805.

The processor 2801 includes one or more processing cores, and the processor 2801 runs various functional applications and performs information processing by running software programs and modules.

The receiver 2802 and the transmitter 2803 are implemented as a communication assembly. The communication assembly may be a communication chip.

The memory 2804 is connected to the processor 2801 by the bus 2805. The memory 2804 is configured to store at least one instruction, and the processor 2801, when loading and executing the at least one instruction, is caused to perform the processes in the above method embodiments.

In addition, the memory 2804 may be implemented using any type of volatile or non-volatile storage device, or a combination of both. Volatile or non-volatile storage devices include, but are not limited to: a disk or optical disc, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

In some exemplary embodiments, a computer-readable storage medium is further provided. The computer-readable storage medium stores at least one program. The at least one program, when loaded and run by the processor, causes the processor to perform the method for managing carriers according to the method embodiments described above.

In some exemplary embodiments, a chip is further provided. The chip includes one or more programmable logic circuits and/or one or more program instructions. The chip, when running on the communication device, is caused to perform the method for managing carriers according to the method embodiments described above.

In some exemplary embodiments, a computer program product is further provided. The computer program product, when running on a processor of a computer device, causes the computer device to perform the method for managing carriers described above.

In some exemplary embodiments, a communication system is further provided. The communication system includes the first terminal, the second terminal, and the network device described above, and is configured to perform the method for managing carriers according to the method embodiments described above.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, wherein the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for managing carriers, applicable to a first terminal, the method comprising:
performing carrier management on at least two carriers with a second terminal in carrier aggregation-based sidelink communication.

2. The method according to claim 1, wherein the at least two carriers are not distinguished as primary and secondary carriers, or the at least two carriers have a same status.

3. The method according to claim 1, wherein the at least two carriers are selected by the first terminal and/or the second terminal based on at least one of self-implementation, a first mapping relationship, a first selection rule, or a first selection configuration;
wherein the first mapping relationship is a mapping relationship for selecting a carrier involved in the carrier aggregation-based sidelink communication, the first selection rule is a selection rule for selecting a carrier involved in the carrier aggregation-based sidelink communication, and the first selection configuration is a selection configuration for selecting a carrier involved in the carrier aggregation-based sidelink communication.

4. The method according to claim 3, wherein the at least two carriers are selected based on at least one of:
a service type;
an application type;
a data transmission type;
a transmission attribute;
quality of service (QOS);
a layer 2 identity (ID);
logical channel mapping;
a resource pool;
a radio bearer;
a resource pool congestion degree;
a data priority; or
link quality or channel condition of a candidate carrier.

5. The method according to claim 1, wherein performing the carrier management on the at least two carriers with the second terminal comprises:
independently transmitting carrier configuration information over each of the at least two carriers.

6. The method according to claim 2, wherein performing the carrier management on the at least two carriers with the second terminal comprises:
transmitting carrier control information to the second terminal over a sidelink message, wherein the carrier control information is used for performing at least one of an add operation, a delete operation, or a modify operation on the at least two carriers.

7. The method according to claim 6, wherein the first terminal is a transmitter terminal, or the first terminal is a receiver terminal.

8. The method according to claim 6, wherein
the carrier control information is generated by the first terminal; or
the carrier control information is configured for the first terminal by a network device.

9. The method according to claim 6, wherein
the carrier control information is carried over each of the at least two carriers for independent transmission; or
the carrier control information is carried over a first carrier among the at least two carriers for transmission, and the carrier control information indicates a carrier controlled by the carrier control information in a case of cross-carrier transmission of the carrier control information over the first carrier,
wherein the first carrier is at least one carrier selected from the at least two carriers.

10. The method according to claim 1, wherein performing the carrier management on the at least two carriers with the second terminal comprises:
transmitting a plurality of pieces of sidelink data to the second terminal over the at least two carriers;
detecting a plurality of physical sidelink feedback channels (PSFCHs) transmitted by the second terminal over a target carrier, wherein the plurality of PSFCHs carry feedback information of the plurality of pieces of sidelink data, the target carrier is each of the at least two carriers or a third carrier, wherein the third carrier is at least one carrier selected from the at least two carriers; and
transmitting a radio link failure (RLF) report to a network device over an uplink carrier and/or transmitting an RLF report to the second terminal over the target carrier in a case that a detection result indicates that an RLF has occurred.

11. The method according to claim 10, wherein
the target carrier is each of the at least two carriers; and
detecting the plurality of PSFCHs transmitted by the second terminal over the target carrier, comprises:
independently detecting the plurality of PSFCHs independently transmitted by the second terminal over each of the at least two carriers, wherein the PSFCH on each of the at least two carriers corresponds to the sidelink data on each of the at least two carriers; and
determining that an RLF has occurred on a fourth carrier in a case that loss of PSFCHs for N consecutive pieces of sidelink data is detected on the fourth carrier, wherein the fourth carrier is one of the at least two carriers.

12. A first terminal, comprising:
a processor;
a transceiver, communicably connected to the processor; and
a memory, configured to store one or more executable instructions, which when executed by the processor, causes the processor to:
perform carrier management on at least two carriers with a second terminal in carrier aggregation-based sidelink communication.

13. The first terminal according to claim 12, wherein the at least two carriers are not distinguished as primary and secondary carriers, or the at least two carriers have a same status.

14. The first terminal according to claim 12, wherein the at least two carriers are selected by the first terminal and/or the second terminal based on at least one of self-implementation, a first mapping relationship, a first selection rule, or a first selection configuration;
wherein the first mapping relationship is a mapping relationship for selecting a carrier involved in the carrier aggregation-based sidelink communication, the first selection rule is a selection rule for selecting a carrier involved in the carrier aggregation-based sidelink communication, and the first selection configuration is a selection configuration for selecting a carrier involved in the carrier aggregation-based sidelink communication.

15. The first terminal according to claim 14, wherein the at least two carriers are selected based on at least one of:
a service type;
an application type;
a data transmission type;
a transmission attribute;
quality of service (QOS);
a layer 2 identity (ID);
logical channel mapping;
a resource pool;
a radio bearer;
a resource pool congestion degree;
a data priority; or
link quality or channel condition of a candidate carrier.

16. The first terminal according to claim 12, wherein the one or more executable instructions, which when executed by the processor, further causes the processor to:
transmit a plurality of pieces of sidelink data to the second terminal over the at least two carriers;
detect a plurality of physical sidelink feedback channels (PSFCHs) transmitted by the second terminal over a target carrier, wherein the plurality of PSFCHs carry feedback information of the plurality of pieces of sidelink data, the target carrier is each of the at least two carriers or a third carrier, wherein the third carrier is at least one carrier selected from the at least two carriers; and
transmit a radio link failure (RLF) report to a network device over an uplink carrier and/or transmitting an RLF report to the second terminal over the target carrier in a case that a detection result indicates that an RLF has occurred.

17. The first terminal according to claim 16, wherein the target carrier is each of the at least two carriers; and
wherein the one or more executable instructions, which when executed by the processor, further causes the processor to:
independently detect the plurality of PSFCHs independently transmitted by the second terminal over each of the at least two carriers, wherein the PSFCH on each of the at least two carriers corresponds to the sidelink data on each of the at least two carriers; and
determine that an RLF has occurred on a fourth carrier in a case that loss of PSFCHs for N consecutive pieces of sidelink data is detected on the fourth carrier, wherein the fourth carrier is one of the at least two carriers.

18. The first terminal according to claim 17, wherein N is defined for a single carrier; and
wherein N is a default value, or a fixed value, or a value configured by the network device, or a value autonomously determined by the first terminal, or a value configured by the second terminal.

19. The first terminal according to claim 17, wherein the one or more executable instructions, which when executed by the processor, further causes the processor to:
perform carrier reselection in a case that an RLF has occurred on the fourth carrier; or
perform carrier reselection in a case that an RLF has occurred on the fourth carrier and at least one carrier where RLF has not occurred is present.

20. A chip, comprising:
one or more programmable logic circuits and/or one or more program instructions, wherein the chip is configured to:
perform carrier management on at least two carriers with a second terminal in carrier aggregation-based sidelink communication.
